(19) United States
(12) Patent Application Publication
(10) Pub. No.: US 2020/0269772 A1
(43) Pub. Date: Aug. 27, 2020

(54) MOTOR VEHICLE ADJUSTMENT DEVICE

(71) Applicant: Huf Huelsbeck & Fuerst GmbH & Co. KG, Velbert (DE)

(72) Inventor: Heiko Schuetz, Velbert (DE)

(73) Assignee: Huf Huelsbeck & Fuerst GmbH & Co. KG, Velbert (DE)

(21) Appl. No.: 16/647,803

(22) PCT Filed: Sep. 6, 2018
(86) PCT No.: PCT/EP2018/074014

§ 371 Date: Mar. 16, 2020

(30) Foreign Application Priority Data
Oct. 5, 2017 (DE) 10 2017 123 153.6

(51) Int. Cl. B60R 11/04; E05F 15/63; G03B 11/04

(52) U.S. Cl. CPC B60R 11/04; B60R 2011/0082; G03B 11/043; E05F 15/63

(57) ABSTRACT

A motor vehicle adjustment device includes a drive element, a first functional element, an intermediate element, and a second functional element. The drive element passes through an intermediate position during its movement from a starting position into an end drive position. The drive element is in mechanical connection with the first functional element that is designed to move out of a starting position as the drive element moves from the starting position into the intermediate position. The drive element is movably coupled to the intermediate element and when the drive element moves from the intermediate position to the end drive position, the intermediate element moves from a basic position to an end drive position. The intermediate element is in mechanical operative connection with the second functional element which is designed to move from a starting position into an end position.

The invention relates to a motor vehicle adjustment device, comprising a drive element, a first functional element, which is movable from a starting position that starts and/or stops a function and back into the starting position by means of the drive element, and a second functional element, which is movable between a starting position that starts and/or stops a function and an end position that starts and/or stops a function, wherein the drive element is mechanically operatively connected to the first functional element and is designed, as it moves from the home position into the intermediate position, to move the first functional element from the starting position that starts and/or stops a function into the intermediate position.

Such a motor vehicle adjustment device is known for example from DE 10 2015 122 993 A1 and has a drive element in order to move a camera unit designed in the manner of a functional element between a rest position as the starting position and an image capture position. A cover flap designed in the manner of a second functional element is pivotally mounted on a housing of the motor vehicle adjustment device and covers an opening in the housing. The cover flap is coupled in motion to the camera unit via an articulated connection in such a way that the cover flap is pivoted open as the camera unit moves from the rest position into the image capture position and the cover flap is pivoted shut as the camera unit moves back into the rest position. The movement coupling of the camera unit and the cover flap represents a disadvantageous restriction of the movement sequences, because the movements of the camera unit and the cover flap can only take place at the same time by means of the coupling, which affects the flexibility of the motor vehicle adjustment device and therefore only makes it usable for a special camera system.

The object of the invention is to provide a solution which provides an improved motor vehicle adjustment device in a structurally simple manner, which is significantly more flexible and can be used not only in a camera system.

This object is achieved according to the invention by a motor vehicle adjustment device having the features according to claim 1.

The motor vehicle adjustment device according to the invention comprises a drive element which is connected in a rotationally fixed manner to a fixed drive axle and which is movable between a home position and an end drive position, a first functional element which, by means of the drive element, is movable out of a starting position that starts and/or stops a function and back into the starting position, an intermediate element which is rotatably mounted about a fixed rotation axle between a basic position and an end drive position and which is movable by means of the drive element, and a second functional element which, by means of the intermediate element, is movable between a starting position that starts and/or stops a function and an end position that starts and/or stops a function. The drive element, as it moves from the home position into the end drive position, is designed to pass through an intermediate position, wherein the drive element is in mechanical operative connection with the first functional element and is designed, as said drive element moves from the home position into the intermediate position, to move the first functional element out of the starting position that starts and/or ends a function. Furthermore, the drive element is motion-coupled to the intermediate element, the drive element being designed, as it moves from the intermediate position into the end drive position, to move the intermediate element from the basic position into the end drive position. The intermediate element is in mechanical operative connection with the second functional element, wherein the intermediate element is designed, as it moves from the basic position into the end drive position, to move the second functional element from the starting position that starts and/or stops a function into the end position that starts and/or stops a function position. In the sense of the invention, a functional element is to be understood as any type of element which takes over a function in a motor vehicle. For example, a functional element in the sense of the invention can be a cover element or a component of a locking mechanism (such as, for example, a rotary latch or a pawl), wherein the movement opens up an opening, in the case of a cover element, or the movement causes for example, an unlocking process, in the case of a locking mechanism.

Advantageous and expedient embodiments and developments of the invention are disclosed in the dependent claims.

The invention provides a motor vehicle adjustment device which can be used flexibly for a wide variety of applications. Due to the fact that the drive element is coupled to the intermediate element in such a way that the drive element, as it moves from the intermediate position to the end drive position, moves the intermediate element from the basic position into the end drive position, the second functional element remains in its starting position until the drive element has reached its intermediate position. On the other hand, the drive element, as it moves from the home position into the end drive position, moves the first functional element out of the starting position. According to the present invention, there is therefore a movement of the second functional element at different times with respect to the movement of the first functional element. The movement of the first functional element can stop when the movement of the second functional element begins. In the sense of the invention, however, it is also conceivable for the first functional element and the second functional element to move simultaneously when the drive element moves from the intermediate position into the end drive position. The idea according to the invention is therefore to be seen in the fact that with the motor vehicle adjustment device according to the invention, movement sequences and/or events coordinated with one another in time can be realized by a first functional element and a second functional element using only one drive element, wherein the movement sequences take place simultaneously and/or with a time delay.

In an embodiment of the motor vehicle adjustment device, the invention provides that the drive element has a drive pin that is radially spaced from the drive axle, the intermediate element having a guide recess that is designed to be radially spaced from the rotation axle and in which the drive pin is movably arranged. The drive pin is consequently positively guided within the guide recess, to which the movement of the drive element is transmitted.

In order to implement a movement sequence and/or event that is coordinated in time with respect to the movement of another element, the invention further provides in an embodiment of the motor vehicle adjustment device that the guide recess of the intermediate element has a first recess portion which has a constant radius with respect to the drive axle of the drive element and has a second recess portion which has an increasing radius with respect to the drive axle of the drive element. It is also conceivable that the second recess portion can have an increasing linear course or also a constant linear course. In particular, the second recess portion can have a mixed course, which is designed in portions having an increasing radius and/or an increasing linear course, and/or a constant linear course.

With regard to a time-coordinated movement sequence and/or event, the invention provides in a further embodiment that the drive pin is arranged to move along the first recess portion as the drive element moves from the starting position into the intermediate position, and the drive pin is arranged to move along the second recess portion and the intermediate element is arranged rotating about the rotation axle as the drive element moves from the intermediate position into the end drive position. Consequently, the movement sequence of the intermediate element is only started by the drive element when the drive element moves from the intermediate position into the end drive position.

To increase the compactness, it is provided in a further embodiment that the motor vehicle adjustment device further has a first coupling element which is pivotably mounted about a first fixed pivot axle between a rest position and a limit position, wherein the first coupling element mechanically operatively connects the drive element to the first functional element.

With regard to temporally coordinated movement sequences and/or events, it is also advantageous if the drive element, as it moves from the home position into the intermediate position, is designed to move the first coupling element from the rest position into the limit position, wherein the drive element has a drive recess which is designed to be radially spaced from the drive axle, wherein the first coupling element is designed having a coupling pin which is arranged radially at a distance from the first pivot axle and which is movably arranged in the drive recess.

For a controlled movement sequence, the invention provides in one embodiment that the drive recess of the drive element comprises a first drive recess portion, which has a decreasing radius with respect to the drive axle, and a second drive recess portion, which has a constant radius with respect to the drive axle. It is also conceivable that the first drive recess portion can have a decreasing linear course or also a constant linear course. In particular, the first drive recess portion can have a mixed course, which is designed in portions having a descending/decreasing radius and/or a descending/decreasing linear course, and/or a constant linear course.

With regard to a time-controlled movement of the first functional element, which is mechanically operatively connected to the drive element via the first coupling element, the invention provides in a further embodiment that the coupling pin is arranged to be movable along the first drive recess portion as the drive element moves from the home position into the intermediate position, and wherein the coupling pin is arranged to be movable along the second drive recess portion and the first coupling element is arranged to rotate about the first fixed pivot axle as the drive element moves from the intermediate position into the end drive position.

A structurally particularly advantageous possibility in an embodiment according to the invention is that the first coupling element is designed having a first lever arm and a second lever arm, wherein the coupling pin is formed at the end of the first lever arm, wherein a coupling projection protrudes from the first functional element, wherein said coupling projection is rotatably connected to a stationary folding axle on the end and is rotatably connected to the second lever arm.

Alternatively, it is also conceivable that the first coupling element has a first lever element which is rotatably mounted about a first fixed lever rotation axle and a second lever element which is rotatably mounted about a second fixed lever rotation axle, wherein the first lever element has a first lever arm on which the coupling pin is formed at the end and a second lever arm on which a lever movement pin is formed at the end, and wherein the second lever element is rotatably connected to the first functional element and has a lever recess guiding the lever movement pin, which is radially offset from the second fixed lever rotation axle.

In an alternative embodiment, the invention provides that the first functional element has a movement guide attachment which is movably arranged in a movement guide recess, wherein the movement guide recess is designed as a stationary elongated hole.

As an alternative to the last-mentioned embodiment, it is also conceivable, in a modification, that the first lever element has a third lever arm, in which an elongated hole is formed, in which a movement guide projection protruding from the first functional element is arranged so as to be movable.

With regard to a chronologically coordinated movement sequence and/or event, the invention provides that the first coupling element is designed, as it moves from the rest position into the limit position, to move the first functional element from the starting position and/or stopping position into the end position.

For another alternative embodiment, the invention provides for the motor vehicle adjustment device that the first coupling element is designed as a lever element having a first lever arm, on which the coupling pin is formed on the end side, and having a second lever arm, wherein the second lever arm is designed having an elongated hole, in which a movement guide projection protruding from the first functional element is arranged in a movably guided manner.

With regard to a temporally parallel movement, it is then provided in an embodiment of the invention that the motor vehicle adjustment device further has a movement lever, of which a first longitudinal end is rotatably connected to the intermediate element and of which a second longitudinal end is rotatably connected to the first functional element. In this way, a sequence of movements and/or an event for the first functional element is now no longer dependent only on the first coupling element but also on the intermediate element.

Accordingly, the invention provides in a further embodiment that the first coupling element is designed, as it moves from the rest position into the limit position, to move the first functional element from the starting position that starts and/or stops a function to an intermediate functional position, wherein the movement lever is designed, as the intermediate element moves from the basic position into the end drive position, to move the first functional element from the intermediate functional position into the end position.

The compactness of the motor vehicle adjustment device according to the invention can be increased in one embodiment by the fact that the motor vehicle adjustment device further has a second coupling element which is pivotably mounted about a second fixed pivot axle between a rest position and a limit position, wherein the second coupling element mechanically operatively connects the intermediate element with the second functional element.

In a further embodiment, the invention provides that the second coupling element is rotatably connected to the second functional element via an articulation point arranged radially spaced from the second fixed pivot axle. Movement of the second coupling element can thus cause movement of the second functional element.

For temporally coordinated movement sequences and/or events, the invention further provides that the intermediate element is designed to move the second coupling element from the rest position into the limit position as said intermediate element moves from the basic position to the end drive position, wherein the second coupling element is designed to move the second functional element from the starting position that starts and/or stops a function into the end position that starts and/or stops a function as said coupling element moves from the rest position into the limit position.

With regard to a positively guided movement, it is further provided in an embodiment of the motor vehicle adjustment device according to the invention that the second coupling element has a coupling recess which is designed to be radially spaced from the second fixed pivot axle, wherein the intermediate element is designed having an intermediate element pin arranged radially spaced from the rotation axle and movably in the coupling recess.

It is provided in a further embodiment that the coupling recess of the second coupling element comprises a first coupling recess portion having an increasing radius with respect to the second fixed pivot axle and a second coupling recess portion, such that different movement sequences and/or events of both motor vehicle adjustment devices can be realized.

Accordingly, it is advantageous in a further embodiment of the invention if the intermediate element pin is arranged to move along the first drive recess portion and the second coupling element is arranged to rotate from the rest position into the limit position as the intermediate element moves from the basic position into the end drive position.

In order to protect the motor vehicle adjustment device from dirt and environmental influences, the invention provides in an embodiment that at least the drive element and the intermediate element are mounted within a protective housing or that a cover element is arranged laterally from the drive element and laterally covers at least the drive element, the intermediate element, and the second functional element.

A further possibility of a compact configuration of the motor vehicle adjustment device is that the first functional element is pivotally mounted about a functional element pivot axle, wherein the functional element pivot axle is relatively movable with respect to the stationary drive axle. In this way, it is possible that the first functional element is not only rotatably or pivotably mounted, but can also be moved in a translational manner.

The guidance of the movement of the second functional element can be supported in a further embodiment of the invention in that the motor vehicle adjustment device further has a guide lever which is rotatably mounted on a stationary guide rotation axle and is rotatably connected to the second functional element with its free lever end.

Finally, it is provided in an embodiment according to the invention that the first functional element is designed as a cover flap and the second functional element is designed as a camera or a camera support, wherein, in the starting position, the cover flap is arranged to cover the camera or the camera support in a protective manner against an external environment and the camera or the camera support is arranged in a protective manner behind the cover flap in the starting position, and wherein, in the end position, the cover flap is arranged to open up a recording area for the camera and the camera or the camera support is arranged in the end position to record the recording area.

It goes without saying that the features mentioned above and those to be explained below can be used not only in the combination indicated but also in other combinations or alone, without leaving the scope of this invention. The scope of the invention is defined only by the claims.

Other details, features, and advantages of the subject matter of the invention can be found in the following description in connection with the drawing, in which exemplary and preferred exemplary embodiments of the invention are presented.

In the drawings:

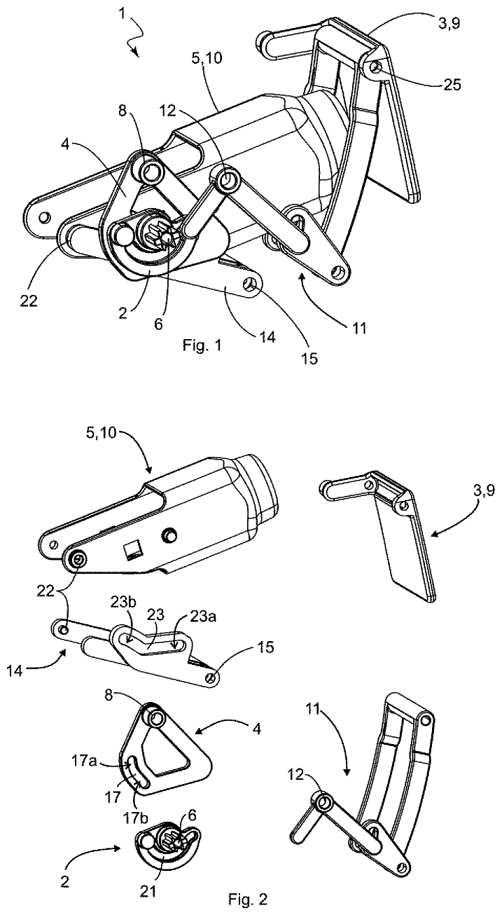

FIG. 1 shows a perspective view of a motor vehicle adjustment device according to the invention in accordance with a first exemplary embodiment,

FIG. 2 shows a perspective individual part view of the motor vehicle adjustment device according to the invention,

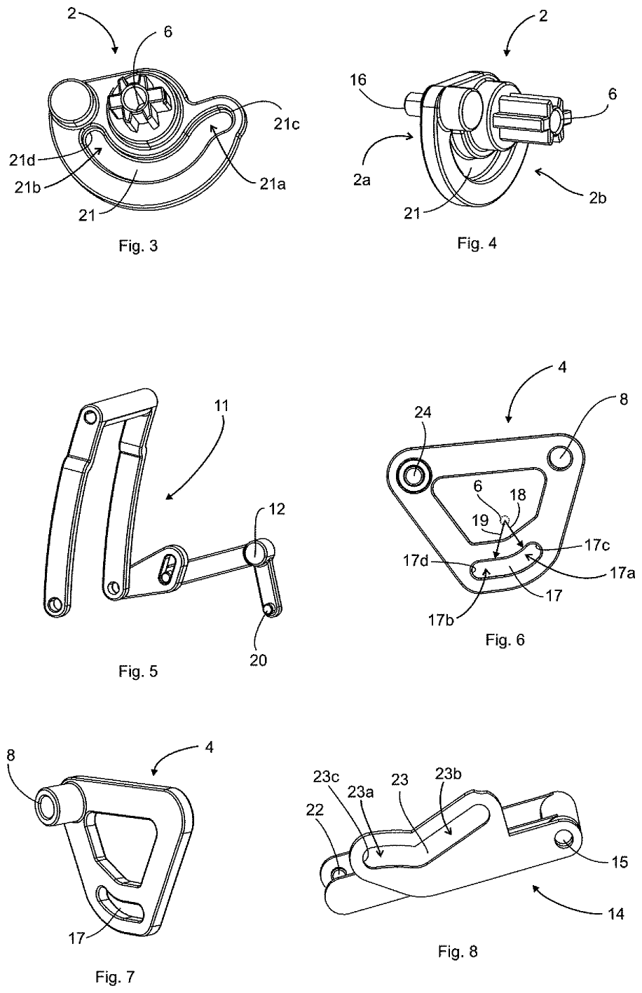

FIG. 3 shows a plan view of a drive element of the motor vehicle adjustment device according to the invention,

FIG. 4 shows a perspective side view of the drive element from FIG. 3,

FIG. 5 shows a perspective view of a first coupling element of the motor vehicle adjustment device according to the invention,

FIG. 6 shows a plan view of an intermediate element of the motor vehicle adjustment device according to the invention,

FIG. 7 shows a perspective side view of the intermediate element from FIG. 6,

FIG. 8 shows a perspective side view of a second coupling element of the motor vehicle adjustment device according to the invention,

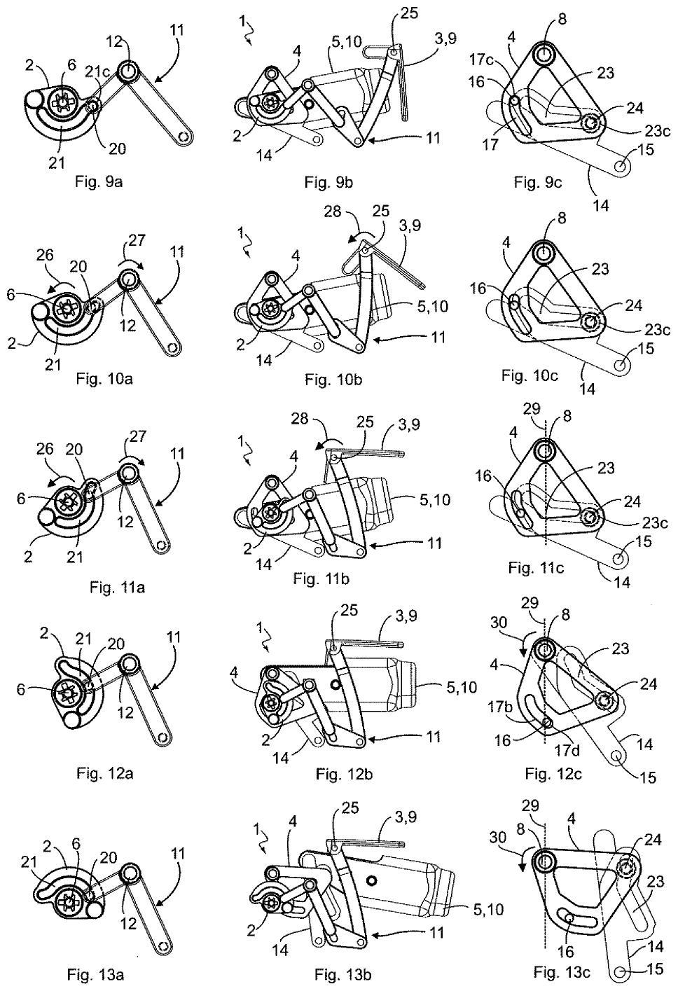

FIG. 9a shows a side view of the drive element arranged in a home position and the first coupling element which is arranged in a rest position,

FIG. 9b shows a side view of the motor vehicle adjustment device according to the invention having the drive element and coupling element arranged according to FIG. 9a,

FIG. 9c shows a side view of the intermediate element arranged in a basic position and the second coupling element arranged in a rest position, wherein the intermediate element and the second coupling element are arranged in respective positions according to FIG. 9b,

FIG. 10a shows a side view of the drive element moved out of the home position thereof and the first coupling element,

FIG. 10b shows a side view of the motor vehicle adjustment device according to the invention having the drive element and coupling element arranged according to FIG. 10a,

FIG. 10c shows a side view of the intermediate element arranged in its basic position and the second coupling element arranged in its rest position,

FIG. 11a shows a side view of the drive element moved into an intermediate position and the first coupling element, which is arranged in a limit position,

FIG. 11b shows a side view of the motor vehicle adjustment device according to the invention having the drive element and coupling element arranged according to FIG. 11a,

FIG. 11c shows a side view of the intermediate element arranged in its basic position and the second coupling element arranged in its rest position,

FIG. 12a shows a side view of the drive element moved out of its intermediate position and the first coupling element, which is arranged in its limit position,

FIG. 12b shows a side view of the motor vehicle adjustment device according to the invention having the drive element and coupling element arranged according to FIG. 12a,

FIG. 12c shows a side view of the intermediate element moved out of its basic position and the second coupling element moved out of its rest position,

FIG. 13a shows a side view of the drive element arranged in an end drive position and the first coupling element, which is arranged in its limit position,

FIG. 13b shows a side view of the motor vehicle adjustment device according to the invention having the drive element and coupling element arranged according to FIG. 13a,

FIG. 13c shows a side view of the intermediate element arranged in an end drive position and the second coupling element arranged in a limit position,

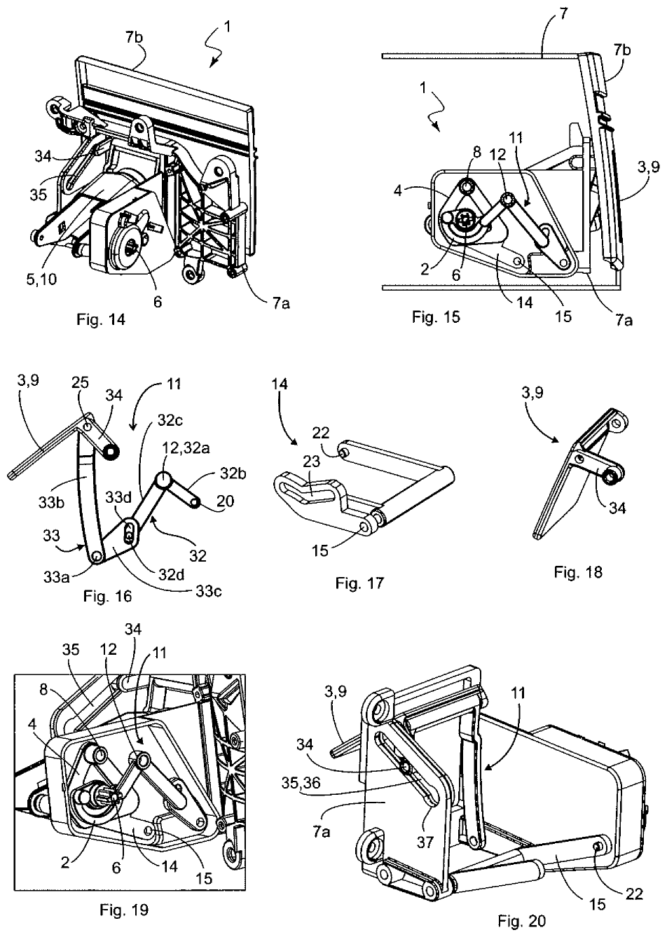

FIG. 14 shows a perspective view of a second exemplary embodiment of a motor vehicle adjustment device according to the invention,

FIG. 15 shows a side view of the motor vehicle adjustment device from FIG. 14,

FIG. 16 shows a side view of a first coupling element of the motor vehicle adjustment device from FIG. 14,

FIG. 17 shows a perspective view of a second coupling element of the motor vehicle adjustment device from FIG. 14,

FIG. 18 shows a perspective view of a first functional element of the motor vehicle adjustment device from FIG. 14,

FIG. 19 shows a detailed view of a drive element, an intermediate element, and the first coupling element of the motor vehicle adjustment device from FIG. 14,

FIG. 20 shows a perspective side view of the motor vehicle adjustment device from FIG. 14 with the omission of certain components,

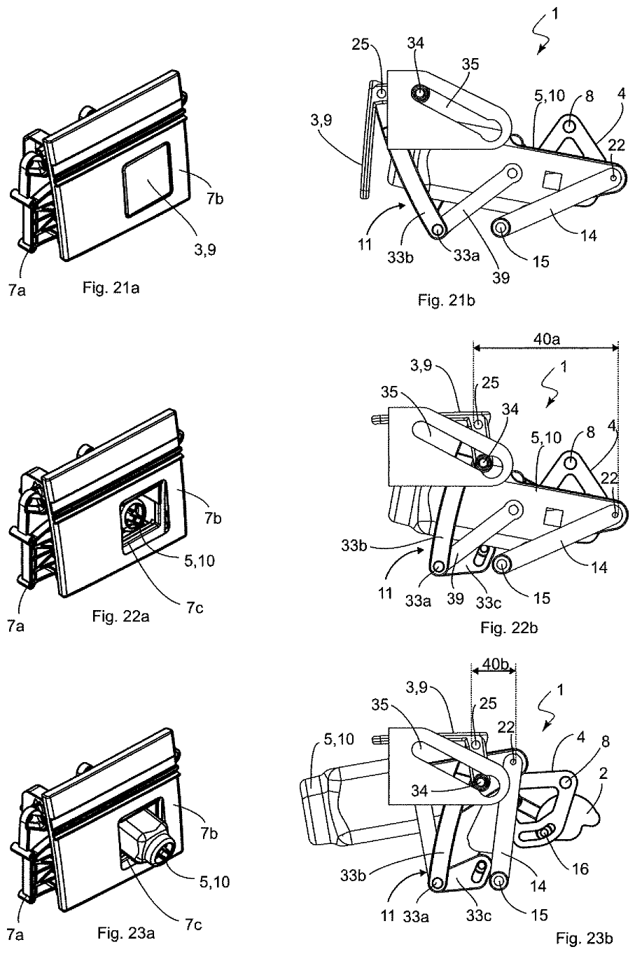

FIG. 21a shows a perspective view of the motor vehicle adjustment device from FIG. 14, in which the drive element is arranged in a home position,

FIG. 21b shows a side view of the motor vehicle adjustment device from FIG. 21a,

FIG. 22a shows a perspective view of the motor vehicle adjustment device from FIG. 14, in which the drive element is arranged in an intermediate position,

FIG. 22b shows a side view of the motor vehicle adjustment device from FIG. 22a,

FIG. 23a shows a perspective view of the motor vehicle adjustment device from FIG. 14, in which the drive element is arranged in an end drive position,

FIG. 23b shows a side view of the motor vehicle adjustment device from FIG. 23a,

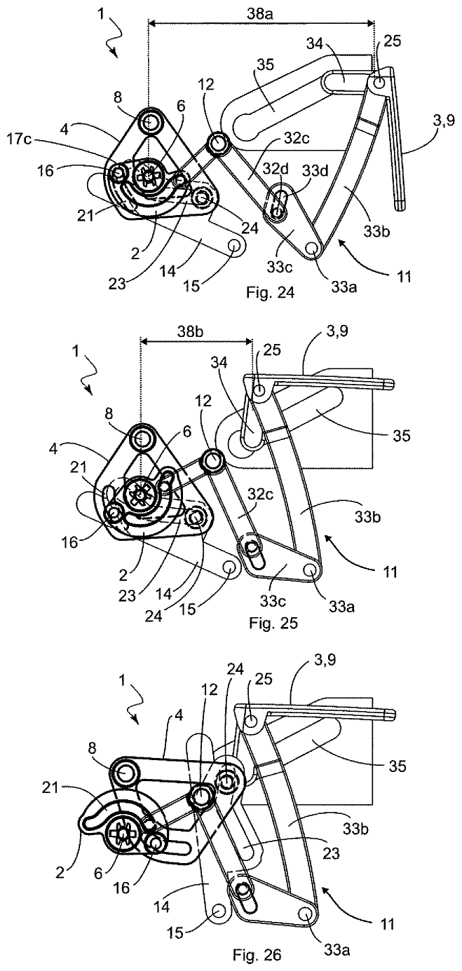

FIG. 24 shows a further side view of the motor vehicle adjustment device from FIG. 14, in which the drive element is arranged in the home position,

FIG. 25 shows a further side view of the motor vehicle adjustment device from FIG. 14, in which the drive element is arranged in the intermediate position,

FIG. 26 shows a further side view of the motor vehicle adjustment device from FIG. 14, in which the drive element is arranged in the end drive position,

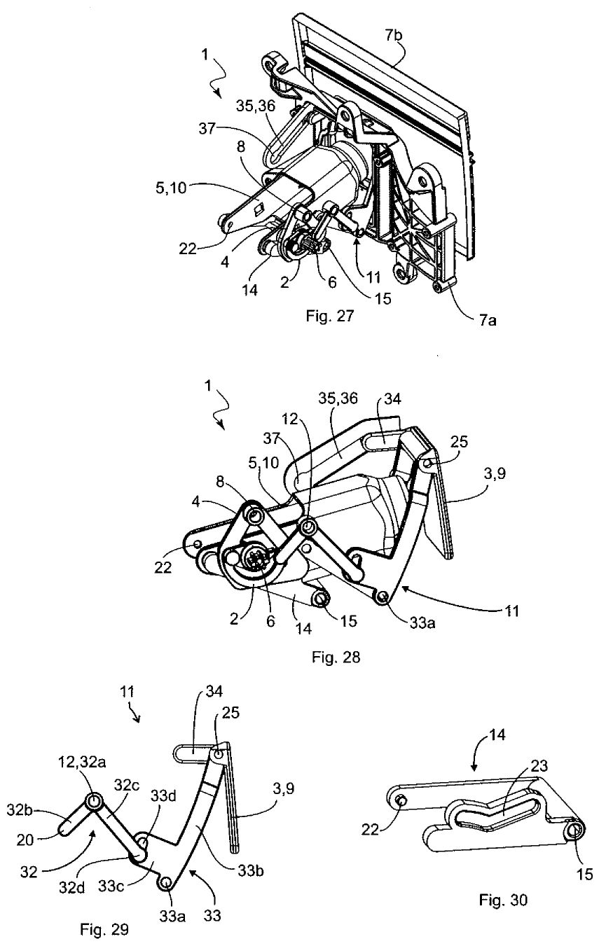

FIG. 27 shows a perspective view of a third exemplary embodiment of a motor vehicle adjustment device according to the invention,

FIG. 28 shows a perspective view of the motor vehicle adjustment device shown in FIG. 27,

FIG. 29 shows a side view of a first coupling element of the motor vehicle adjustment device shown in FIG. 27,

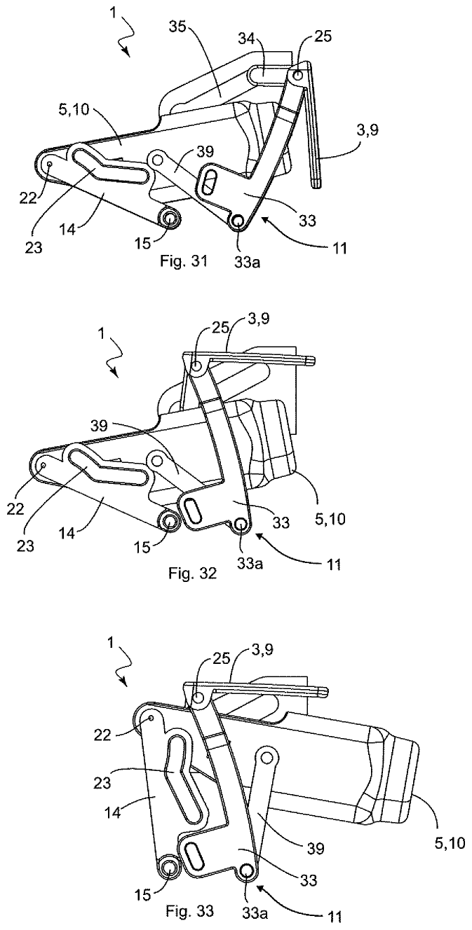

FIG. 30 shows a perspective view of a second coupling element of the motor vehicle adjustment device shown in FIG. 27,

FIG. 31 shows a side view of a first and second functional element and of a first and second coupling element of the motor vehicle adjustment device shown in FIG. 27, wherein the first coupling element is arranged in a rest position and the second coupling element is arranged in a rest position,

FIG. 32 shows a side view of the first and second functional element and of the first and second coupling element of the motor vehicle adjustment device shown in FIG. 27, wherein the first coupling element is arranged in a limit position and the second coupling element is arranged in the rest position,

FIG. 33 shows a side view of the first and second functional element and of the first and second coupling element of the motor vehicle adjustment device shown in FIG. 27, wherein the first coupling element is arranged in the limit position and the second coupling element is arranged in a limit position,

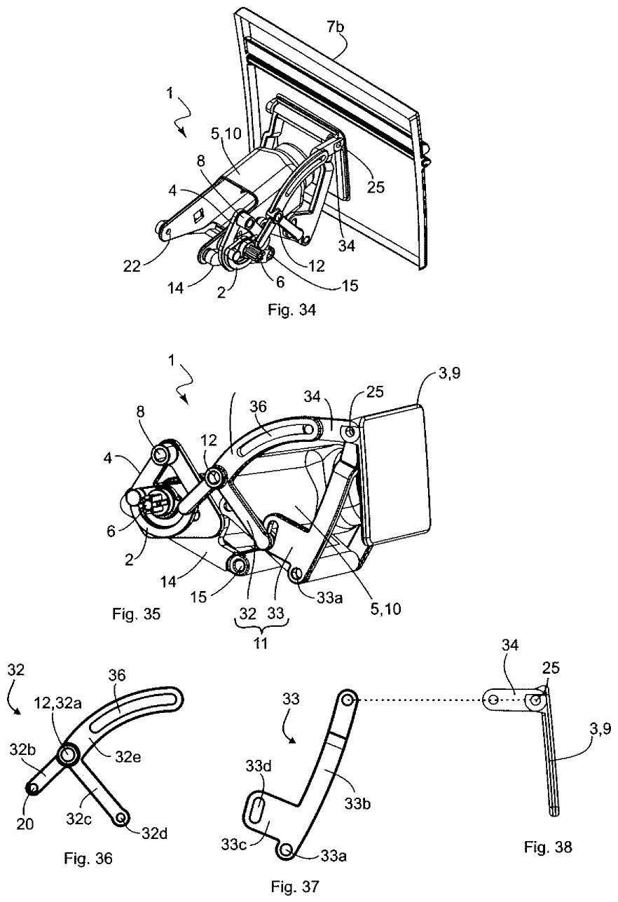

FIG. 34 shows a perspective view of a fourth exemplary embodiment of a motor vehicle adjustment device according to the invention,

FIG. 35 is a perspective view of the motor vehicle adjustment device shown in FIG. 34,

FIG. 36 shows a side view of a first lever element of a first coupling element of the motor vehicle adjustment device shown in FIG. 34,

FIG. 37 shows a side view of a second lever element of a first coupling element of the motor vehicle adjustment device shown in FIG. 34,

FIG. 38 shows a side view of a first functional element of the motor vehicle adjustment device shown in FIG. 34

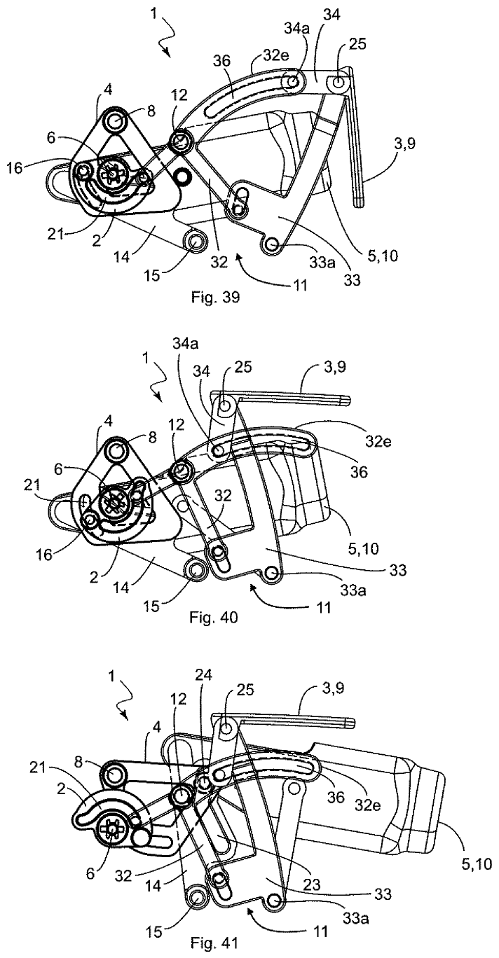

FIG. 39 shows a side view of the motor vehicle adjustment device shown in FIG. 34, wherein a drive element of the motor vehicle adjustment device is arranged in a home position,

FIG. 40 shows a side view of the motor vehicle adjustment device shown in FIG. 34, wherein the drive element of the motor vehicle adjustment device is arranged in an intermediate position,

FIG. 41 shows a side view of the motor vehicle adjustment device shown in FIG. 34, wherein the drive element of the motor vehicle adjustment device is arranged in an end drive position,

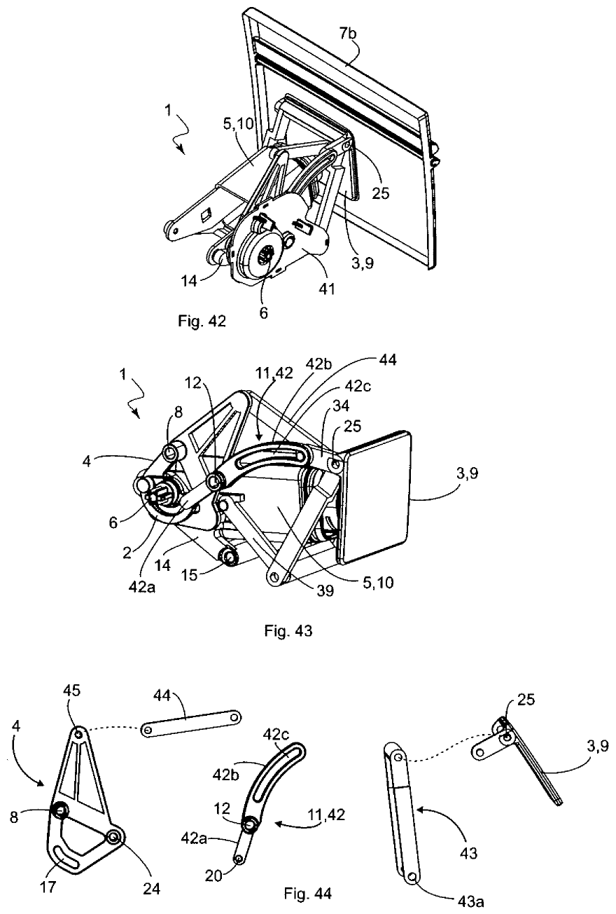

FIG. 42 shows a perspective view of a fifth exemplary embodiment of a motor vehicle adjustment device according to the invention,

FIG. 43 shows a perspective view of the motor vehicle adjustment device shown in FIG. 42,

FIG. 44 shows a side view of a first coupling element and a first functional element of the motor vehicle adjustment device shown in FIG. 43,

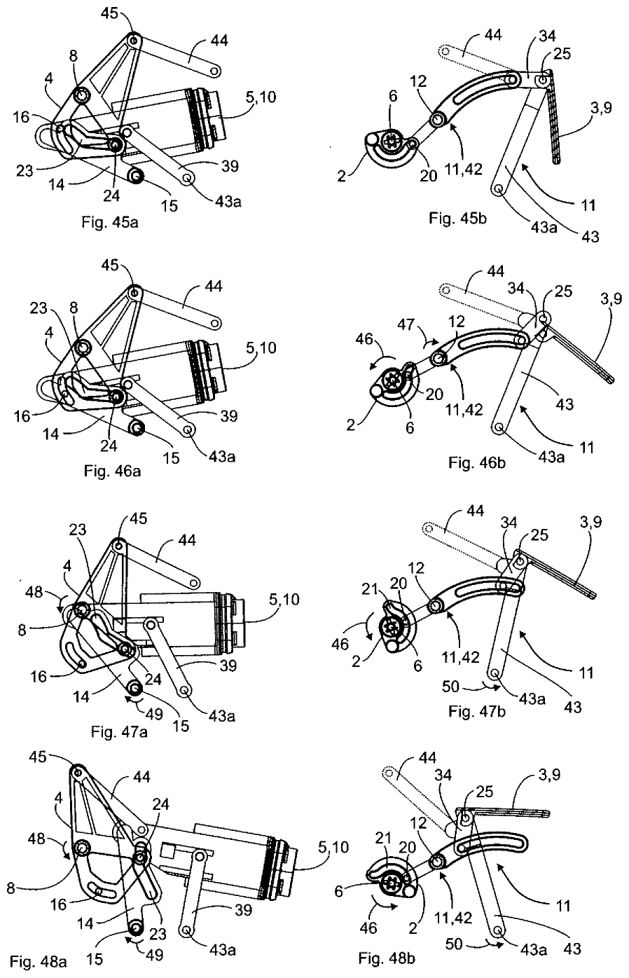

FIG. 45a shows a side view of a second functional element, an intermediate element, and a second coupling element of the motor vehicle adjustment device shown in FIG. 42, wherein the second functional element is arranged in a starting position,

FIG. 45b shows a side view of a first functional element, a drive element, and the first coupling element of the motor vehicle adjustment device shown in FIG. 42, wherein the first functional element is arranged in a starting position,

FIG. 46a shows a side view of the second functional element, the intermediate element, and the second coupling element of the motor vehicle adjustment device shown in FIG. 42, wherein the second functional element is arranged in the starting position,

FIG. 46b shows a side view of the first functional element, the drive element and the first coupling element of the motor vehicle adjustment device shown in FIG. 42, wherein the first functional element is arranged in an intermediate functional position,

FIG. 47a shows a side view of the second functional element, the intermediate element, and the second coupling element of the motor vehicle adjustment device shown in FIG. 42, wherein the second functional element is arranged in a position moved out of the starting position,

FIG. 47b shows a side view of the first functional element, the drive element and the first coupling element of the motor vehicle adjustment device shown in FIG. 42, wherein the first functional element is arranged in the intermediate functional position,

FIG. 48a shows a side view of the second functional element, the intermediate element and the second coupling element of the motor vehicle adjustment device shown in FIG. 42, wherein the second functional element is arranged in an end position,

FIG. 48b shows a side view of the first functional element, the drive element and the first coupling element of the motor vehicle adjustment device shown in FIG. 42, wherein the first functional element is arranged in an end position,

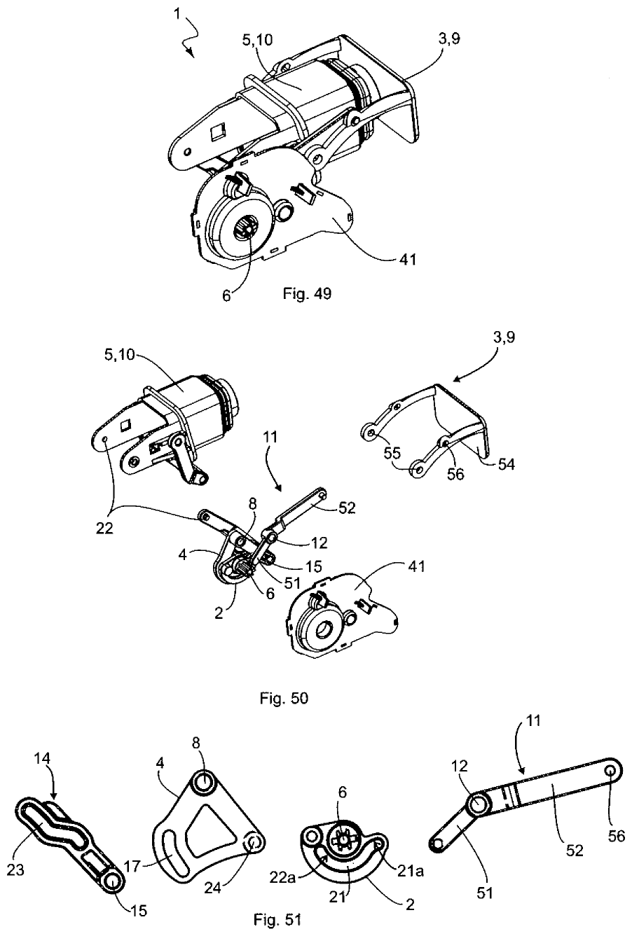

FIG. 49 shows a perspective view of a sixth exemplary embodiment of a motor vehicle adjustment device according to the invention,

FIG. 50 shows a perspective partial illustration of the motor vehicle adjustment device shown in FIG. 49,

FIG. 51 shows a side view of a second coupling element, an intermediate element, a drive element, and a first coupling element of the motor vehicle adjustment device shown in FIG. 49,

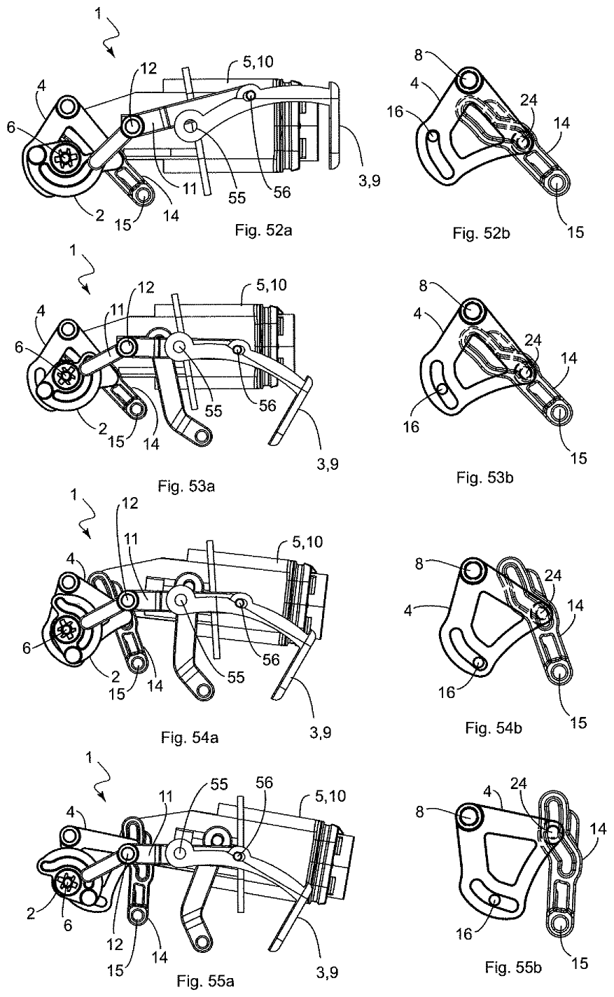

FIG. 52a shows a side view of the motor vehicle adjustment device shown in FIG. 49, the drive element being arranged in a home position,

FIG. 52b shows a side view of the intermediate element and the second coupling element when the drive element is arranged in the home position,

FIG. 53a shows a side view of the motor vehicle adjustment device shown in FIG. 49, the drive element being arranged in an intermediate position,

FIG. 53b shows a side view of the intermediate element and the second coupling element when the drive element is arranged in the intermediate position,

FIG. 54a shows a side view of the motor vehicle adjustment device shown in FIG. 49, wherein the drive element is arranged in a position moved out of the intermediate position,

FIG. 54b shows a side view of the intermediate element and the second coupling element when the drive element is arranged in the position moved out of the intermediate position,

FIG. 55a is a side view of the motor vehicle adjustment device shown in FIG. 49, wherein the drive element is arranged in an end drive position, and

FIG. 55b is a side view of the intermediate element and the second coupling element when the drive element is arranged in the end drive position.

Insofar as the same reference numerals are used below in the different embodiments, these relate to identical or the same elements or components, so that the unique description of the elements or components of one embodiment also applies to the other embodiments.

FIG. 1 shows a first exemplary embodiment of a motor vehicle adjustment device 1, wherein FIG. 2 shows a perspective individual part representation of the motor vehicle adjustment device 1 according to the invention. The motor vehicle adjustment device 1 shown in FIGS. 1 and 2 comprises a drive element 2, a first functional element 3, an intermediate element 4, and a second functional element 5. The drive element 2 is connected to a fixed drive axle 6 and is mounted on the latter. The drive element 2 is rotatably connected to the drive axle 6, which in turn can be driven, for example, by an electric motor. The first functional element 3 can be moved with the aid of the drive element 2, wherein the drive element 2 is also in mechanical operative connection with the intermediate element 4, so that the drive element 2 moves both the first functional element 3 and the intermediate element 4. The intermediate element 4 is rotatably mounted about a stationary rotation axle 8, the mounting being able to take place, for example, on a support assembly 7, as is shown by way of example for a second exemplary embodiment in FIG. 15 and applies to all the exemplary embodiments shown in FIGS. 1 to 55b. The support assembly 7 can in turn be attached to the body or to another location of a motor vehicle. The intermediate element 4, which can be moved with the aid of the drive element 2, is coupled to the second functional element 5 such that the second functional element 5 can be moved by means of the intermediate element 4.

For the present invention, a functional element 3, 5 is to be understood as any type of component which takes over a function in a motor vehicle. Thus, a functional element within the meaning of the invention can be, for example, a cover element or a component of a locking mechanism (such as a rotary latch or a pawl), wherein the movement opens or closes an opening in the case of a covering element or the movement, for example, causes an unlocking process in the case of a locking mechanism. Depending on the position of the functional element 3, 5, the desired function can be started and/or stopped. In FIGS. 1 to 55b, the first functional element 3 is designed as a cover flap 9, whereas the second functional element 5 is designed as a camera support 10. As mentioned above, the invention is not limited to these two components (cover flap 9 and camera support 10). Rather, the idea of the invention is to be clarified on the basis of the cover flap 9 and the camera support 10, which is to be seen in the fact that with the motor vehicle adjusting device 1 according to the invention, movement sequences and/or events that are coordinated in time with one another can be realized by the first functional element 3 and a second functional element 5 using only a single drive element 2, wherein the movement sequences take place simultaneously and/or with a time delay.

As can also be seen from FIGS. 1 and 2, the drive element 2 is not connected directly to the first functional element 3 or the cover flap 9. Rather, a first coupling element 11 is provided, which is pivotably mounted about a first fixed pivot axle 12 and which mechanically operatively connects the drive element 2 to the first functional element 3, wherein the fixed mounting can also take place on the support assembly 7. Furthermore, the second functional element 5 is not directly coupled to the intermediate element 4. Rather, the coupling takes place via a second coupling element 14 which is pivotably mounted about a second fixed pivot axle 15 and which mechanically operatively connects the intermediate element 4 to the second functional element 5. The second pivot axle 15 can also be mounted in a stationary manner on the support assembly 7. “Fixed” in the sense of the invention means that these are axes which are not moved with respect to movable components of the motor vehicle adjustment device 1, but which represent a fixed point for the components of the motor vehicle adjustment device 1. It should be noted that the first coupling element 11 and the second coupling element 12 could be omitted in the motor vehicle adjustment device 1 according to the invention, which is shown for various exemplary embodiments in FIGS. 1 to 55b. Thus, it is also conceivable that the drive element 2 can be connected directly to the first functional element 3 and the intermediate element 4 can be connected directly to the second functional element 5. The two coupling elements 11 and 12, however, allow a compact installation space to be achieved, wherein the two coupling elements 11 and 12 also provide advantageous leverage ratios by means of which the movement sequences of the two functional elements 3 and 5 can be coordinated with one another in time and, if necessary, accelerated or decelerated.

The individual components of the motor vehicle adjustment device 1 are shown individually in different views in FIGS. 3 to 8. As can be seen from FIGS. 3 and 4, the drive element 2 is disc-shaped. The drive element 2 has a drive pin 16 which is radially spaced from the drive axle 6. The drive pin 16 formed at a radial distance from the drive axle 6 protrudes from a first side surface 2a of the drive element 2 and extends parallel to the drive axle 6. The intermediate element 4, which is shown in FIGS. 6 and 7, has a guide recess 17 which is designed to run radially spaced from the rotation axle 8. The drive pin 16, which can move along the guide recess 17, is arranged in the guide recess 17 which is formed at a radial distance from the rotation axle 9. The guide recess 17 of the intermediate element 4 has a first recess portion 17a and a second recess portion 17b. The first recess portion 17a has a constant radius 18 with respect to the drive axle 6 of the drive element 2. In other words, the first recess portion 17a runs along the radius 18, which is related to the drive axle 6. This constant radius 18 corresponds to the distance between the drive axle 6 and the drive pin 16, so that it can be seen that the first recess portion 17a represents a neutral radius for the drive pin 16, in which a movement of the drive pin 16 does not cause any movement of the intermediate element 4. The second recess portion 17b, on the other hand, has a radius 19 that increases with respect to the constant radius 18, so that the drive pin 16 presses against the edge of the second recess portion 17b during its movement and thereby rotates the intermediate element 4 about the rotation axle 4. It is also conceivable that the second recess portion 17b can have an increasing linear course or also a constant linear course. In particular, the second recess portion 17b can have a mixed course, which is designed in portions having an increasing radius and/or an increasing linear course, and/or a constant linear course.

As can be seen from FIG. 5, the first coupling element 11 has a coupling pin 20. The coupling pin 20 is formed radially spaced from the first pivot axle 12 on the first coupling element 11. The drive element 2 has a drive recess 21 on a side surface 2b facing away from the first side surface 2a, as can be seen from FIGS. 3 and 4. The coupling pin 20 of the first coupling element 11 is movably arranged in the drive recess 21 of the drive element 2. It can be seen in FIG. 3 that the drive recess 21 of the drive element 2 has a first drive recess portion 21a and a second drive recess portion 21b. The first drive recess portion 21a is designed with a decreasing radius with respect to the drive axle 6, whereas the second drive recess portion 21b is designed with a constant radius with respect to the drive axle 6. The first drive recess portion 21a is consequently formed having a radius that becomes smaller with respect to the drive axle 6. Alternatively, it is also conceivable that the first drive recess portion 21a can have a decreasing linear course or also a constant linear course. In particular, the first drive recess portion 21a can have a mixed course, which is designed in portions having a decreasing radius and/or a decreasing linear course, and/or a constant linear course. In the first exemplary embodiment, the first coupling element 11 is designed as a multi-part lever mechanism which is rotatably connected to the first functional element 3 or the cover flap 9. More specifically, the first functional element 3 is pivotally mounted about a functional element pivot axle 25, wherein the functional element pivot axle 25 is relatively movable relative to the stationary drive axle 6. However, the precise design of the lever mechanism is not dealt with for the first exemplary embodiment, since there are various designs for the first coupling element which are the subject matter of the other exemplary embodiments, which will be described below. Rather, an overview of the interaction of all components is to be given on the basis of the first exemplary embodiment, without going into the specific configuration of the first coupling element 11.

As can also be seen from the overview of FIGS. 1 and 2, the second coupling element 14 is rotatably connected to the second functional element 5 via an articulation point 22 arranged radially spaced from the second fixed pivot axle 15. For coupling to the intermediate element 4, the second coupling element 14 has a coupling recess 23. The coupling recess 23 is radially spaced from the second fixed pivot axle 15, as can be seen, for example, from FIGS. 2 and 8. The coupling recess 23 of the second coupling element 14 has a first coupling recess portion 23a and a second coupling recess portion 23b. The first coupling recess portion 23a is formed having an increasing radius with respect to the second fixed pivot axle 15. Furthermore, the intermediate element 4 is formed having an intermediate element pin 24 arranged radially spaced from the rotation axle 8, which is movably arranged in the coupling recess 23. The interaction of the individual components of the motor vehicle adjustment device 1 will now be described with reference to FIGS. 9a to 13c, wherein the interaction of the drive element 2, the first functional element 3, the intermediate element 4, the second functional element 5, the first coupling element 11, and the second coupling element 14 is identical for all exemplary embodiments of FIGS. 1 to 55b, such that, for the exemplary embodiments of FIGS. 14 to 55b, reference is made to the functional description provided above and below for the first exemplary embodiment of FIGS. 1 to 13c.

FIGS. 9a, 9b, and 9c show side views in which the drive element 2 is arranged in a home position. In the home position of the drive element 2, the first coupling element 11 is arranged in a rest position, the first functional element 3 is arranged in a starting position, the intermediate element 4 is arranged in a basic position, the second coupling element 14 is arranged in a rest position, and the second functional element 5 is arranged in a starting position. The starting position of the first functional element 3 and/or the second functional element 5 is a position in which a function is started or stopped. Since the exemplary embodiments in FIGS. 1 to 55b relate to a camera system of a motor vehicle, in which the first functional element 3 is designed as a cover flap 9 and the second functional element 5 is designed as a camera support 10, the starting position of the first functional element 3 is a position with respect to the specific exemplary embodiments in which the cover flap 9 closes an opening in, for example, a vehicle body, and the starting position of the second functional element 5 is a position in which the camera support 10 is arranged behind the cover flap 9 in a retracted manner within the vehicle body. In the rest position, the coupling pin 20 of the first coupling element 11 is arranged at a stop end 21c of the first drive recess portion 21a of the drive recess 21, whereas the drive pin 16 of the drive element 2 is arranged at a stop end 17c of the first recess portion 17a of the guide recess 17. Furthermore, the intermediate element pin 24 is arranged on a stop end 23c of the first coupling recess portion 23a of the coupling recess 23.

With reference to FIGS. 10a, 10b, and 10c, an electric motor is now started, for example, for rotating the drive axle 6 of the drive element 2, as a result of which the drive axle 6, which is connected to the electric motor, turns the drive element 2 counterclockwise (see arrow 26 in FIG. 10a). During this movement of the drive element 2, the edge of the first drive recess portion 21a of the drive recess 21 presses against the coupling pin 20 of the first coupling element 11, as a result of which the first coupling element 11, which is designed as a two-armed lever or as an angle lever in the first exemplary embodiment, pivots clockwise (see arrow 27 in FIG. 10b) about the first pivot axle 12. As a result of this pivoting movement, the lever mechanism of the first coupling element 11 moves the functional element pivot axle 25 of the first functional element 3. In other words, the first coupling element 11 moves the functional element pivot axle 25 of the cover flap 9 in the direction of the drive axle 6, wherein a guide (not shown in FIGS. 9a to 13c) additionally pivots or swings open the cover flap 9 counterclockwise about the functional element pivot axle 25 (see arrow 28 in FIG. 10b). As the drive element 2 moves out of its home position, the drive pin 16 moves along the first recess portion 17a of the guide recess 17 of the intermediate element 4. Since the first recess portion 17a of the guide recess 17 has a constant radius 18 with respect to the drive axle 6, the movement of the drive pin 16 runs on a neutral radius, so that the intermediate element 4 remains stationary in its basic position during this movement of the drive element 2. Consequently, during this movement of the drive element 2, the second coupling element 14 also remains arranged in its rest position and the second functional element 5 in the home position thereof.

Referent to FIGS. 11a, 11b and 11c, the drive element 2 is now arranged in an intermediate position. In the intermediate position of the drive element 2, the first coupling element 11 is arranged in a limit position. In the limit position, the first coupling element 11 has moved the first functional element 3 into an end position in the first exemplary embodiment. As can be seen in FIG. 11b, the first coupling element 11 has pivoted the first functional element 3 or the cover flap 9 into the end position as said coupling element moved from the rest position into the limit position (see FIG. 11b) and has swung open so far that an opening is opened up, through which a camera positioned on the camera support 10 can record. In particular, in the intermediate position of the drive element 2, the coupling pin 20 of the first coupling element 11 is arranged at the transition from the first drive recess portion 21a to the second drive recess portion 21b. The second functional element 5 or the camera support 10 is still arranged in the intermediate position of the drive element 2 in the starting position, because, in the intermediate position of the drive element 2, the drive pin 16 of the drive element 2 is at the transition from the first recess portion 17a to the second recess portion 17b of the guide recess 17 of the intermediate element 4 (see FIG. 11c), such that the intermediate element 4 is still arranged in the basic position, which can also be seen from the fact that the intermediate element pin 24 is still arranged in an unmoving state at the stop end 23c of the first coupling recess portion 23a. Accordingly, the second coupling element 14 is still arranged in the rest position.

FIGS. 12a, 12b, and 12c show positions in which the drive element 2 is moved from the intermediate position into the direction of an end drive position (this is shown for example in FIG. 13a). During this movement of the drive element 2, the first coupling element 11 remains in its limit position, such that the second drive recess portion 21b moves past the coupling pin 20. Since the second drive recess portion 21b has a constant radius, the first coupling element 11 does not move and remains in its limit position, as a result of which the first functional element 3 also remains arranged in its end position (see FIG. 12b). The arrangement of the coupling pin 20 in the second drive recess portion 21b represents a kind of locking of the first functional element 3 in its end position, because a movement of the first functional element 3 back into its starting position is not possible due to the arrangement of the coupling pin 20 within the second drive recess portion 21b. The second drive recess portion 21b blocks a movement of the first functional element 3 back into its starting position when the coupling pin 20 is arranged within the second drive recess portion 21b, When the drive element 2 moves from the intermediate position in the direction of the end drive position, the drive pin 16 also presses against the edge of the second recess portion 17b and is in the position shown in FIG. 12c at a stop end 17d of the second recess portion 17b. In this position, the drive pin 16 is arranged perpendicular to the rotation axle 8 of the intermediate element 4, which is shown by the vertical line 29 shown in broken lines in FIG. 12c, Furthermore, when the drive element 2 moves from the intermediate position in the direction of the end drive position, the intermediate element pin 24 of the intermediate element 4 presses against the edge of the first coupling recess portion 23a of the coupling recess 23 (see FIG. 12c), as a result of which the second coupling element 14 rotates clockwise about the second pivot axle 15 (see arrow 30 in FIG. 12c). The pivoting movement of the second coupling element 14 also causes a movement of the second functional element 5, such that the second functional element 5 is moved out of its starting position. In particular, the second coupling element 14, as it moves from the rest position in the direction of its limit position, which is shown in FIG. 13b, causes a movement of the second functional element 5 or the camera support 10 in a direction away from the drive axle 6.

In FIGS. 13a, 13b, and 13c, the drive element 2 has now reached its end drive position. The first coupling element 11 is arranged in its limit position, such that the first functional element 3 is still arranged in its end position, i.e. the cover flap 9 is arranged in an open position. As the drive element 2 moves from the position shown in FIG. 12a into the end drive position shown in FIG. 13a, the drive pin 16 continues to press against the edge of the second recess portion 17b However, the drive pin 16 travels back from the stop end 17d of the second recess portion 17b in the direction of the first recess portion 17a, but the drive pin 16 remains in the second recess portion 17b and the intermediate element 4 continues to rotate counterclockwise about the rotation axle 8. The intermediate element 4 executes a kind of rollover when the drive element 2 moves from the intermediate position into the end drive position, with the drive pin 16 exceeding the vertical 29 during this movement of the drive element 2. The drive element 2 consequently moves the intermediate element 4 into the end drive position. As a result of the rotational movement of the intermediate element 4 in its end drive position, the intermediate element pin 24 presses against the edge of the coupling recess 23 of the second coupling element 14, such that the intermediate element pin 24 of the intermediate element 4 pivots the second coupling element clockwise about the second pivot axle 15 and reaches into the second coupling recess portion 23b (see FIG. 13c). The intermediate element 4 moves the second coupling element 14 into a limit position shown in FIGS. 13b and 13c, wherein the second functional element 5 is moved into an end position shown in FIG. 13b as a result of a mechanical operative connection between the second coupling element 14 and the second functional element 5. In this end position, the second functional element 14 is now moved further away from the drive axle 6 of the drive element 2. The second functional element 14, which is designed as a camera mount 10, sinks below the first functional element 3, which is designed as a cover flap 9, and reaches a position in which capturing an image of an outside area of a motor vehicle is possible.

In order to move the first functional element 3 and the second functional element 5 back into the respective starting positions thereof, the drive element 2 is rotated clockwise by the drive axle 6, as a result of which the above movement sequences are reversed and all the components return to the home positions thereof as shown in FIGS. 9a, 9b, and 9c.

The interaction of the individual components of the motor vehicle adjustment device 1 with reference to FIGS. 9a to 13c consequently has the effect that the first functional element 3 can be moved out of the starting position that starts and/or stops a function and back into the starting position by means of the drive element 2. The intermediate element 4, which is rotatably mounted between its basic position and its end drive position, is motion-coupled to the drive element 2, wherein the second functional element 5 is movable by means of the intermediate element 4 between the starting position that starts and/or ends a function and an end position that starts and/or ends a function. The drive element 2 is designed to pass through the intermediate position during its movement from the starting position into the end drive position and is in mechanical operative connection with the first functional element 3 such that the drive element 2 moves the first functional element 3 out of one starting position that starts and/or ends a function as said drive element moves from home position into the intermediate position. However, the drive element 2 is also movably coupled to the intermediate element 4 in such a way that the drive element 2, as it moves from the intermediate position into the end drive position, moves the intermediate element 4 from the basic position into the end drive position. The intermediate element 4 is also in mechanical operative connection with the second functional element 5 in such a way that the intermediate element 4, as it moves from the basic position into the end drive position, moves the second functional element 5 from the starting position that starts and/or ends a function into an end position that starts and/or ends a function. When the drive element 2 moves from the home position into the intermediate position, the drive pin 16 is designed to move along the first recess portion 17a, wherein the drive pin 16 is designed to move along the second recess portion 17b and the intermediate element 4 is designed to rotate about the rotation axle 8 as the drive element 2 moves from the intermediate position into the end drive position. The first coupling element 11 provides a mechanical operative connection between the drive element 2 and the first functional element 3. The drive element 2 is designed to move the first coupling element 11 from the rest position into the limit position as it moves from the home position into the intermediate position. Correspondingly, the coupling pin 20 is arranged to move along the first drive recess portion 21a as the drive element 2 moves from the home position into the intermediate position, wherein the coupling pin 20 is arranged to move along the second drive recess portion 21b and the first coupling element 11 is arranged to rotate about the first fixed pivot axle 12 as the drive element 2 moves from the intermediate position into the end drive position. Finally, the second coupling element 14 establishes a mechanical operative connection between the intermediate element 4 and the second functional element 5. In this case, the intermediate element 4 is designed to move the second coupling element 14 from the rest position into the limit position as said intermediate element moves from the basic position into the end drive position, wherein the second coupling element 14, as it moves from the rest position into the limit position, is designed to move the second functional element 5 from a starting position that starts and/or stops a function into an end position that starts and/or stops a function. For this purpose, when the intermediate element 4 moves from the basic position into the end drive position, the intermediate element pin 24 is arranged to move along the first drive recess portion 23a and the second coupling element 14 is arranged to rotate from the rest position into the limit position.

FIGS. 14 to 26 show a second exemplary embodiment of the motor vehicle adjustment device 1 according to the invention. As can be clearly seen from FIG. 14, the motor vehicle adjustment device 1 is arranged behind a support assembly 7 and fastened to the latter, wherein the fastening assembly 7 includes a fastening support 7a, via which the motor vehicle adjustment device 1 is fixed on the rear side of a body wall 7b. The first functional element 3, which is designed as a cover flap 9 of a camera system (front or rear view camera system) in the exemplary embodiments shown in the figures, is intended to close an opening 7c in the body wall 7b (see for example FIG. 21a), such that the camera system is arranged behind the body wall 7b, in a protected manner against external weather influences, or to open up said opening (see, for example, FIG. 23a), such that the camera system can record the outside area in front of or behind the motor vehicle. The cover flap 9 must open up the opening 7c in order for the camera system, which is equivalent to the motor vehicle adjustment device 1 according to the invention, or a camera of the camera system to record the outside area. Consequently, the function of the first functional element 3, which is designed as a cover flap 9, is either to close the opening 7c or to open it. Accordingly, the starting position that starts a function is defined as the position in which the first functional element 3 or the cover flap 9 closes the opening 7c, wherein the function includes the closing of the opening 7c and the associated protection of the camera system or the motor vehicle adjustment device 1. The end position that stops a function is a position in which the first functional element 3 or the cover flap 9 opens the opening 7c. The function of the second functional element 5, which in the exemplary embodiments is designed as a camera support 10, is either designed to be arranged in a protected rest position behind the body wall 7b or to record the outside area of the motor vehicle. Accordingly, the starting position starting a function is defined as the position in which the second functional element 5 or the camera support 10 is arranged behind the body wall 7c in a protected manner. The end position stopping a function is then a position in which the second functional element 3 or the camera support 10 is extended out of the opening 7c and in this position can accommodate the exterior of the motor vehicle. The motor vehicle adjustment device 1 according to the invention now makes it possible to carry out the movement sequences for changing the positions of the first functional element 3 and the second functional element 5 in a time-coordinated manner. For the second exemplary embodiment in FIGS. 14 to 26, this means that first the first functional element 3 is moved behind the body wall 7b, as a result of which the opening 7c is opened. Only then is the second functional element 5 moved in the direction of the opening 7c and at least partially extended out of the opening 7c in order to be able to accommodate the outside area of the motor vehicle. The movement sequences of the first functional element 3 thus take place at least partially before the movement sequences of the second functional element 5, because it is also conceivable that the first functional element 3 partially opens the opening before the second functional element 5 is moved. When the first functional element 3 moves behind the body wall 7b, the second functional element 5 could then also be moved simultaneously, so that the movement sequences of the first and second functional elements 3, 5 take place at least partially simultaneously.

In the second exemplary embodiment, the drive element 2 and the intermediate element 4 are completely encapsulated by a protective housing 31 fastened to the fastening support 7a, as can be seen from FIGS. 14, 15, 19 and 20. Only the drive axle 6 partially protrudes from the protective housing 31 and can be coupled to an electric motor, for example, in order to rotate the drive element 2 from the home position into the end drive position and back. Furthermore, the first coupling element 11 and the second coupling element 14 are only partially arranged within the cover element 31, wherein the part arranged within the protective housing 31 is shown in FIGS. 15 and 19. The part of the second coupling element 14 arranged inside the cover element 31 is connected to the part lying outside the cover element 31 via the second pivot axle 15, which is guided through an opening in the wall of the cover element 31, as can be seen from the overview of FIGS. 15 to 20. The part of the second coupling element 14 lying outside the cover element 31 is U-shaped (see, for example, FIGS. 17 and 20), wherein the two legs of the U each have an articulation point 22 at their free end, via which the second coupling element 14 is rotatably connected to the second functional element 5, i.e. the camera support 10. The first coupling element 11 is designed in a plurality of parts and comprises a first lever element 32 and a second lever element 33. The first lever element 32 is designed having two arms and is rotatably mounted about a first fixed lever rotation axle 32a, the first lever rotation axle 32a corresponding to the first pivot axle 12 (see, for example, FIG. 16). Due to the two-arm design, the first lever element 32 has a first lever arm 32b and a second lever arm 32c, wherein the coupling pin 20 is formed on the first lever arm 32b and the second lever arm 32c has a lever movement pin 32d. The first lever arm 32 is coupled in motion to the second lever element 33 via the lever movement pin 32d, wherein the first lever arm 32 is rotatable relative to the second lever arm 33. The second lever element 33 is rotatably mounted about a second fixed lever rotation axle 33a and is also designed in the manner of a two-armed lever. A first lever arm 33b of the second lever element 33 is rotatably connected to the first functional element 3 via the functional element pivot axle 25, as can be seen for example from FIG. 16. In a second lever arm 33c of the second lever element 33, a lever recess 33d is formed, which is radially offset from the second fixed lever rotation axle 33a and in which the lever movement pin 32d of the first lever element 32 is movably guided. When the first lever element 32 rotates about the first lever rotation axle 32a or about the first pivot axle 12, the lever movement pin 32d presses against the edge of the lever recess 33d and moves within the lever recess 33d, whereby the second lever element 33 is rotated about its lever rotation axle 33a, whereby in turn, the functional element pivot axle 25 is moved, which is not stationary but movable relative to the drive axle 6. While the first lever element 32 is arranged completely inside the protective housing 31, the second lever arm 33c of the second lever element 33 is arranged inside the protective housing 31, whereas the first lever arm 33b is arranged outside the protective housing 31. The first lever arm 33b and the second lever arm 33c are coupled in a rotationally fixed manner via the second lever rotation axle 33a. The first functional element 3 has a movement guide projection 34 which projects perpendicularly from the flap portion of the first functional element 3 so that the cover flap 9 or the first functional element 3 can be pivoted open. A movement guide recess 35 is also formed on the mounting bracket 7a and is arranged to extend laterally from the second functional element 5. In this case, the movement guide extension 34 is movably arranged in the movement guide recess 35, which is designed as a stationary elongated hole 36 on the fastening bracket 7a, as can be seen, for example, from FIG. 20. The elongated hole 36 is formed with a hole-shaped widened portion 37, which serves to ensure that dirt adhering to the movement guide extension 34 can be separated from the widened portion 37, thereby advantageously ensuring the functionality of the guide of the movement guide extension 34.

FIGS. 21a to 26, which are described below, show the functioning of the motor vehicle adjustment device 1 according to the invention. In FIGS. 21a, 21b, and 24c, the drive element 2 is in the home position, wherein, in said position, the first coupling element 11 is arranged in the rest position thereof, in which the coupling pin 20 is arranged on the stop end 21e of the drive element 2, the first functional element 3 or the cover flap 9 is arranged in the starting position thereof, in which it closes the opening 7c in the body wall 7b (see FIG. 21a), the intermediate element 4 is arranged in the basic position thereof, in which the drive pin 16 of the drive element 2 abuts on the stop end 17c of the intermediate element 17, the second coupling element 14 is arranged in the rest position thereof, in which the intermediate element pin 24 of the intermediate element 4 abuts on the stop end 23c of the second coupling element 14, and the second functional element or the camera support 10 are arranged in the rest position thereof, in which the camera support 10 is arranged behind the cover flap 9 in a retracted non-use position (see also FIGS. 9a, 9b, and 9c, which are also valid for the second embodiment). As can be seen in particular from FIG. 21b, the camera support 10 is pivotably mounted via a one-armed guide lever 39. The guide lever 39 guides the movement of the second functional element 5 or the camera support 10. With its free lever end, the guide lever 39 is rotatably connected to the second functional element 5, wherein the guide lever 39 is rotatably mounted on the support assembly 7, for example, via the stationary second lever rotation axle 33a.

The drive axle 6 is driven such that the drive element 2 is rotated counterclockwise and reaches the intermediate position shown in FIGS. 22a, 22b and 25. In the intermediate position, the first functional element 3 has reached its end position, i.e. the cover flap 9 opens the opening 7c and is pivoted in behind the body wall 7b. In the intermediate position of the drive element 2, the coupling pin 20 of the first coupling element 11 is located at the transition from the first drive recess portion 21a to the second drive recess portion 21b, wherein the drive element 2 rotates the first lever element 32 about the first pivot axle 12 or the first lever rotation axle 32a, such that the first coupling element 11 is arranged in its limit position. As the first lever element 32 rotates, the lever movement pin 32d presses against the edge of the lever recess 33d of the second lever element 33 and thereby rotates the second lever element 32 about the second lever rotation axle 33a. During this rotation, the first lever arm 33b of the second lever element 33 moves toward the second lever arm 32c of the first lever element 32, wherein the functional element pivot axle 25 also moves in the direction of the drive axle 6. The second functional element 5 or the camera support 10 is still arranged in the starting position. A distance 38a between the functional element pivot axle 25 and the drive axle 6 in the home position of the drive element 2 (see FIG. 24) is greater than a distance 38b between the functional element pivot axle 25 and the drive axle 6 in the intermediate position of the drive element 2 (see FIG. 25).

When the drive axle 6 is driven further, the drive element 2 moves from its intermediate position into its end drive position, which is reached in FIGS. 23a, 23b, and 26. During this movement, the first coupling element 11 and the first functional element 5 remain in the position described above. On the other hand, during this movement of the drive element 2, the drive pin 16 presses against the edge of the guide recess 17 of the intermediate element 4 and rotates the intermediate element 4 counterclockwise with respect to FIG. 26 about the rotation axle 8. During this rotation of the intermediate element 4, the intermediate element pin 24 presses against the edge of the coupling recess 23 and thereby pivots the second coupling element 14 in a clockwise direction with respect to FIG. 26 about the second pivot axle 15. The second coupling element 14 is consequently moved in the direction of the first lever arm 33b of the second lever element 33 of the first coupling element 11, so that the second coupling element 14 is arranged in its limit position. In the limit position of the second coupling element 14, the second functional element 5 assumes its end position, in which the camera support 10 is arranged in the direction of the opening 7c and at least partially protrudes from the opening 7c. A distance 40a between the functional element pivot axle 25 and the articulation point 22 in the intermediate position of the drive element 2 (see FIG. 22b) is greater than a distance 40b between the functional element pivot axle 25 and the articulation point 22 in the end drive position of the drive element 2 (see FIG. 22c). The second exemplary embodiment, which is shown in FIGS. 14 to 26, is distinguished on the basis of the special configuration of the first coupling element 11 in that a small lever path is sufficient for a translation that is at the same time quickly responsive.

A third exemplary embodiment of the motor vehicle adjustment device 1 according to the invention is shown in FIG. 27 to 33. In contrast to the second exemplary embodiment, no protective housing is provided in the third exemplary embodiment, which results in certain simplifications of the construction, resulting in cost savings for the motor vehicle adjustment device according to the third exemplary embodiment. In the third exemplary embodiment, the second lever element 33 of the first coupling element 11 is now designed as a one-piece, two-armed lever, in which the first lever arm 33b and the second lever arm 33c are made in one piece (see FIG. 29) and are not connected to each other via a non-rotatable connection, as is the case in the second exemplary embodiment, (in this case, the second lever rotation axle 33a of the second lever element 33). The description of FIG. 16, in which a rear view of the first coupling element 11 of the second exemplary embodiment is shown, also applies to the first coupling element 11 of the third embodiment, wherein FIG. 29 shows a front view of the first coupling element 11. The second coupling element 14 (see FIG. 30) is also of simpler design due to the omission of the protective housing 31, but still has the shape known from the second exemplary embodiment. FIGS. 27 and 28 show different perspective views of the motor vehicle adjustment device 1 according to the third exemplary embodiment, wherein the movement guide recess 35 in turn is attached to the mounting bracket 7a and causes, in cooperation with the movement guide extension 34 of the first functional element 3 or the cover flap 9, the pivoting movement of the cover flap 9 as the drive element 2 is moved from the home position (see FIG. 31) into its intermediate position (see FIG. 32). This sequence of movements is shown in FIGS. 31 and 32, wherein only the second lever element 33 of the first coupling element 11, the second coupling element 14, the first functional element 3, and the second functional element 5 are shown in these figures for the sake of clarity. The individual components of the third exemplary embodiment, with the differences mentioned above, correspond to those of the second exemplary embodiment, so that the description for the second exemplary embodiment also applies to the third exemplary embodiment in order to avoid repetitions. For that matter, the functional description of FIGS. 9a to 13c applies to all of the exemplary embodiments which have already been described above and below.

As can be seen from FIGS. 31 and 32, when the drive element 2 moves from the home position into the intermediate position, the second coupling element 14, which is in mechanical operative connection with the second functional element 5, remains in the rest position thereof. On the other hand, as the drive element 2 moves from the home position into the intermediate position, the first coupling element 11 is moved from the rest position thereof into the limit position thereof. During this movement of the first coupling element 11, the drive element 2 pivots the first lever element 32 about the first lever rotation axle 32a and pivots the second lever element 33 about the second lever rotation axle 33a, wherein the direction of rotation of the first lever element 32 is opposite to the direction of rotation of the second lever element 33. As a result, the drive element 2 moves the second lever element 33 in the direction of the second coupling element 5. The first lever element 32 is arranged between the second lever element 33 and the second coupling element 14. If the drive element 2 is then moved from the intermediate position into the end drive position, the drive element 2 moves the second coupling element 14 in the direction of the second lever element 33, as can be seen in FIG. 33. The movement of the second lever element 33 in the direction of the second coupling element 14 and the movement of the second coupling element 14 in the direction of the second lever element 33 demonstrate the compact design of the motor vehicle adjustment device 1.

FIGS. 34 to 41 show a fourth exemplary embodiment of the motor vehicle adjustment device 1 according to the invention. In contrast to the third exemplary embodiment, in the fourth exemplary embodiment there is no movement guide recess 35 having an elongated hole formed on the support assembly 7. Rather, an elongated hole 36 is formed on a third lever arm 32e of the first lever element 32, as can be seen in FIGS. 34 and 35. In the elongated hole 36, the movement guide projection 34 protruding from the first functional element 3 is arranged so as to be movable in order to pivot open the cover flap 9 or the first functional element 3.

FIG. 38 shows the first functional element 3 having its functional element pivot axle 25 and its movement guide extension 34, which is arranged in the elongated hole 36 in a guided manner. FIG. 36 also shows the first lever element 32, whereas FIG. 37 shows the second lever element 33. The first lever element 32, which is rotatably supported about the first pivot axle 12 or the first lever rotation axle 32a, and the second lever element 33, which is rotatably supported about the second lever rotation axle 33a, form the first coupling element 11, whereby by means of the lever movement pin 32d, which is arranged in the lever recess 33d, the first lever element 32 is movable relative to the second lever element 33. As FIG. 36 shows, the first lever element 32 of the coupling element 11 has the first lever arm 32b having the coupling pin 20, the second lever arm 32c having the lever movement pin 33d and the third lever arm 32e having the elongated hole 36. The elongated hole 36 extends radially from the first pivot axle 12 or the first lever rotation axle 32a. In the fourth exemplary embodiment, the first lever element 32 is consequently designed as a three-armed lever.

The mode of operation of the fourth exemplary embodiment is illustrated with reference to FIGS. 39 to 41. The kinematics between the drive element 2, the first lever arm 32 of the first coupling element 11, the intermediate element 4, the second coupling element 14, and the second functional element 5 correspond to the kinematics that have already been described for FIGS. 9a to 13c, so that reference is made to this description for details of the kinematics. For the fourth exemplary embodiment, the drive element 2 rotates the first lever element 32 about the first pivot axle 12 or the first lever rotation axle 32a clockwise as it moves from the home position (see FIG. 39) into the intermediate position thereof (see FIG. 40), as can be seen in FIGS. 39 and 40. The lever movement pin 32d presses against the edge of the lever recess 33d and moves within the lever recess 33d, such that the second lever element 33 is rotated counterclockwise about the second lever rotation axle 33a. Due to the movement of the second lever element 33, the second lever element 33 moves the functional element pivot axle 25 in the direction of the drive axle 6, wherein an extension pin 34a formed on the movement guide extension 34 is additionally positively guided in the elongated hole 34. The shoulder pin 34a is forcibly moved when the drive element 2 is moved in the elongated hole 36 in the direction of the drive axle 6, such that the first functional element 1 rotates about its functional element pivot axle 25, as a result of which the opening 7c in the body wall 7b is opened. After the movement of the first functional element 3 has been completed and the first functional element 3 is moved from its starting position into its end position, the movement of the second functional element 5 takes place as the drive element 2 moves from the intermediate position into the end drive position, as has already been described above. Since only the intermediate element 4, the second coupling element 14, and the second functional element 5, but not the first coupling element 11 and the first functional element 3, are moved during this movement in the fourth exemplary embodiment, reference is made to the description of the previous exemplary embodiments, in which the sequence of movements is described in detail, in particular for FIGS. 9a to 13c. The fourth exemplary embodiment consequently differs from the second and third exemplary embodiments in that the movement guide extension 34 having its extension pin 34e is no longer executed by a fixed guide, such as the movement guide recess 35 formed on the support assembly 7, but rather takes place on an elongated hole 36 which is moved along with the first coupling element 11, wherein the first coupling element 11 has the additional lever arm 32e, in which the elongated hole 36 is formed. The fourth exemplary embodiment thus has the advantage of a component reduction compared to the second and third exemplary embodiments.

For the second, third and fourth exemplary embodiment, the first coupling element 11 is designed, as it moves from the rest position into the limit position, to move the first functional element 3 from the starting position that starts and/or stops the function into the end position. Consequently, the first functional element 3 no longer moves when the first coupling element 11 is arranged in its limit position and when the drive element 2 has reached its intermediate position,

The fifth exemplary embodiment, which is shown in FIGS. 42 to 48b, differs from the movement sequence described last in that, in the intermediate position of the drive element 2, the first functional element 3 is now arranged in an intermediate functional position instead of in the end position (see FIGS. 46a and 46b), although the first coupling element 11 has reached its limit position. Accordingly, in the fifth exemplary embodiment, when moving from the rest position into the limit position, the first coupling element 11 is designed to move the first functional element 3 from the starting position that starts and/or stops a function into an intermediate function position. The movement of the first functional element 3 into the intermediate functional position is characterized in that the first functional element 3 or the cover flap 9 is pivoted about the functional element pivot axle 25. However, as the first coupling element 11 is moved, the functional element pivot axle 25 is not moved with respect to the drive axle 6, but remains in its original position without being moved. Only when the drive element 2 moves from the intermediate position into the end drive position is the first functional element 3 moved from the intermediate function position into the end position, as a result of which the fifth exemplary embodiment differs from the previously described exemplary embodiments. Accordingly, in the fifth exemplary embodiment, when the drive element 2 moves from the intermediate position into the end drive position, the functional element pivot axle 25 moves in the direction of the drive axle 6.

FIGS. 42 to 44 show the structural design of the fifth exemplary embodiment, wherein a description of components of the previous exemplary embodiments is dispensed with and instead reference is made to the above description, which also applies to the fifth exemplary embodiment—with the exception of the differences described. First of all, it can be seen from FIG. 42 that the motor vehicle adjustment device 1 has a cover element 41. The cover element 41 is arranged laterally from the drive element 2 and laterally covers the drive element 2, the intermediate element 4, and the second functional element 5 at least in its starting position. In FIG. 43, the cover element 41 and the body wall 7b have been left out in order to obtain a better view of the motor vehicle adjustment device 1. FIG. 44, on the other hand, shows some selected components that are provided for the movement of the first functional element 3 or the cover flap 9 in the fifth exemplary embodiment. The first coupling element 11 is designed as a two-armed lever element 42 and accordingly has a first lever arm 42a and a second lever arm 42b, which extend essentially diametrically from the first pivot axle 12. The coupling pin 20, which is coupled to the drive element 2, is formed on the first lever arm 42a. Furthermore, the second lever arm 42b is formed having an elongated hole 43c, in which the movement guide projection 34 protruding from the first functional element 3 is arranged so as to be movable. The motor vehicle adjustment device 1 according to the fifth exemplary embodiment further comprises a guide lever 43, which is designed to guide a movement of the functional element pivot axle 25 in the direction of the drive axle 6. The guide lever 43 is connected at the end in an articulated manner to the functional element pivot axle 25 and is also mounted on a fixed lever axle 43a, on which the guide lever 39 for the second functional element 5 is also mounted. Furthermore, the motor vehicle adjustment device 1 has a movement lever 44 which couples the intermediate element 4 to the first functional element 3. More specifically, a first longitudinal end of the movement lever 44 is rotatably connected to the intermediate element 4, wherein a second longitudinal end of the movement lever 44 is rotatably connected to the first functional element 3 (see, for example, FIG. 43). The second longitudinal end of the movement lever 44 can alternatively be rotatably or articulately connected to the guide lever 43 instead of to the first functional element 3. Regardless of whether the movement lever 44 is articulately connected to the functional element 3 or the guide lever 43, as the intermediate element 4 moves from the basic position into the end drive position, the movement lever 44 is designed to move the first functional element 11 from the intermediate function position into the end position, which will be discussed in more detail below. The first longitudinal end of the movement lever 44 is rotatably attached to an articulation point 45 of the intermediate element 4. The pivot point 45 is formed at a radial distance from the rotation axle 8 of the intermediate element 4 and is diametrically opposite the guide recess 17 of the intermediate element 4. The pivot point 45 is at a greater distance from the drive axle 6 than the guide recess 17.

The movement sequences of the fifth exemplary embodiment are described below with reference to FIGS. 45a to 48b, wherein the core movement sequences for the drive element 2, the first coupling element 11, the intermediate element 4, and the second coupling element 14 have already been described for FIGS. 9a to 13c and are also valid for the fifth embodiment. The differences and deviations are therefore discussed in detail below. FIGS. 45a and 45b show side views of the motor vehicle adjustment device 1, wherein the first and second functional elements 3, 5 each are arranged in their starting position and the drive element 2 is arranged in the home position thereof. Based on the specific fifth exemplary embodiment for a camera system, FIGS. 45a and 45b consequently show a state in which the cover flap 9 closes the opening 7c in the body wall 7b and the camera support 10 is arranged behind the cover element 9 in a manner protected from external weather influences.

If the drive axle 6 is now driven by an electric motor, the drive element 2 which is connected to the drive axle 6 in a rotationally fixed manner, rotates, for example, counterclockwise (see arrow 46) and first reaches its intermediate position, for which the arrangement of the individual components of the motor vehicle adjustment device 1 is shown in FIGS. 46a and 46b. Due to the mechanical operative connection between the drive element 2 and the first coupling element 11, which is designed as the two-armed lever element 42, the first coupling element 11 is rotated clockwise about the first pivot axle 12 (see arrow 47), so that the first coupling element 11 is arranged in its limit position. In its limit position, however, the first coupling element 11 has only moved the first functional element 3 into an intermediate functional position and not yet into the end position. In the intermediate function position, the first functional element 3 is only pivoted counterclockwise about the functional element pivot axle 25 (see FIG. 46b). Accordingly, the first functional element 3 or the cover flap 9 is arranged in the intermediate functional position in a pivoted position, in which the cover flap 9 opens part of the opening 7c in the body wall 7b. However, the cover flap 9 has not yet been completely moved out of the opening 7c, although the movement sequence of the first coupling element 11 has been completed. When the drive element 2 moves from the home position (see FIGS. 45a and 45b) into the intermediate position (see FIGS. 46a and 46b), the intermediate element 4 remains in the basic position thereof and the second coupling element in the rest position thereof.

When the drive axle 6 is driven further, the drive element 2 connected to it in a rotationally fixed manner reaches the position shown in FIGS. 47a and 47b, which lies between the intermediate position (see FIG. 46a) and the end drive position (see FIG. 48a), As can be seen, the drive element 2 moves the intermediate element 4 out of the basic position, whereas the first coupling element 11 remains stationary in its limit position. The intermediate element 4 that is rotated counterclockwise about the rotation axle 8 (see arrow 48) no longer only moves the second coupling element 14 out of its rest position (see arrow 49), but instead ensures via the movement lever 4 that the first functional element 3 both extends further about the functional element pivot axle 25 and also moves in the direction of the drive axle 6, for which purpose the guide lever 43 rotates counterclockwise about the lever axle 43a (see arrow 50). The second functional element 5 or the cover flap 9 consequently rotates about the functional element pivot axle 25, wherein the functional element pivot axle 25 is also moved in the direction of the drive axle 6 when the drive element 2 moves from the intermediate position in the direction of the end drive position.

When the drive axle 6 is driven even further, the drive element 2 then reaches its end drive position, which is shown in FIGS. 48a and 48b. In this position, the first coupling element 11 is still arranged in its end position, whereas now the intermediate element 4 has reached its end drive position and the second coupling element 14 has reached its limit position. When moving into the limit position, the coupling element 14 moves the second functional element 5 into the end position, as before in the case of other exemplary embodiments. On the other hand, the movement of the intermediate element 4 ensures that the first functional element 3 reaches its end position in that the intermediate element 4 pulls the functional element pivot axle 25 in the direction of the drive axle 6 via the movement lever 44, wherein the guidance of the movement guide projection 34 in the elongated hole 42c of the second lever arm 42b of the lever element 42 or of the first coupling element 11 ensures a pivoting of the first functional element 3.

In the fifth exemplary embodiment, the first functional element 3 is pivoted about the functional element pivot axle 25 in a first movement phase, in which the drive element 2 is moved from the home position into the intermediate position thereof. In a second movement phase, in which the drive element 2 is moved from the intermediate position into the end drive position thereof, both the first functional element 3 and the second functional element 5 are moving, wherein the second functional element 5 moves from its starting position into its end position, whereas the first functional element 3 is brought into its end position, the intermediate element 4 pivots the first functional element 3 about its functional element pivot axle 25 and moves the functional element pivot axle 25 in the direction of the drive axle 25. Movement sequences for the first functional element 3 and the second functional element 5 are consequently coordinated with one another wherein a partial movement of the first functional element 3 takes place simultaneously with an overall movement of the second functional element 5.

Finally, a sixth exemplary embodiment of the motor vehicle adjustment device 1 is shown in FIGS. 49 to 55b. In this exemplary embodiment, a cover element 41 is again provided, which is arranged on the side of the drive element 2 and laterally covers the drive element 2, the intermediate element 4, and the second functional element 5 at least in its starting position (see, for example, FIG. 49). The sixth exemplary embodiment differs from the previously described exemplary embodiments by the configuration of the first functional element 3 and the first coupling element 11. The other components that are required for the movement sequences correspond to the components described above (drive element 2, intermediate element 4, second coupling element 14, second functional element 5), such that a detailed description is dispensed with and reference is instead made to the exemplary embodiments described above, especially since the movement sequences for the second functional element 5 or for the camera support 10 are identical. As can be seen from FIGS. 50 and 51, the first coupling element 11 is formed having a first lever arm 51 and a second lever arm 52, wherein the coupling pin 20 is formed at the end of the first lever arm 51 and is mechanically operatively connected to the drive element 2. The first functional element 3 also has a coupling projection 53, which projects from a flap-like main part 54 of the first functional element 3. The coupling projection 53 is rotatably supported at the end on a stationary folding axle 55, wherein an articulation point 56 is formed on the coupling projection 53, to which the second lever arm 52 of the first coupling element 11 is rotatably connected, wherein the connection between the folding axle 55 and the main part 54 is arranged and formed on the coupling projection 53.

FIGS. 52a to 55b show the different movement sequences, wherein the drive element 2 is arranged in the home position thereof in FIG. 52a, the intermediate element 4 is arranged in the basic position thereof in FIG. 52b, the drive element 2 is arranged in the intermediate position thereof in FIG. 53a, the intermediate element 4 is further arranged in the basic position thereof in FIG. 53b, the drive element 2 is arranged moved out of its intermediate position in FIG. 54a, the intermediate element 4 is arranged moved out of the basic position thereof in FIG. 54b, the drive element 2 is arranged in the end drive position thereof in FIG. 55a, and the intermediate element 4 is arranged in the end drive position thereof in FIG. 55b. The positions of FIG. 52b correspond to FIG. 9c, the positions of FIG. 53b correspond to FIG. 11c, the positions of FIG. 54b correspond to FIG. 12c and the positions of FIG. 55b correspond to FIG. 13c, such that reference is made to the description of the corresponding figures in order to avoid repetition, because the description therein also applies to the corresponding movement sequences of the sixth embodiment. The movement coupling for the first coupling element 11 via the coupling pin 20 and the drive recess 21 with the drive element 2 and the movement coupling of the drive element 2 via the intermediate element 4 and the second coupling element 14 with the second functional element 5 also correspond to the movement couplings described for FIGS. 9a to 13c, such that reference is made to these explanations, which also apply to the sixth embodiment. In contrast to the previous exemplary embodiments, in the sixth exemplary embodiment the first functional element 3 is mounted on the stationary folding axle 55, such that the pivoting movement of the first coupling element 11, as a result of the mechanical operative connection with the drive element 2, leads to a pivoting of the first functional element 3 about the folding axle 55, as can be seen in FIGS. 52a and 53a. A movement of the folding axle 55 in the direction of the drive axle 6 is not provided in the sixth embodiment. Otherwise, the movement sequences in the sixth exemplary embodiment are the same as the movement sequences of the second, third and fourth exemplary embodiment, i.e. movement sequences of the first and second functional elements 3, 5 coordinated with one another take place, wherein the movement sequences take place at different times.

In summary, a motor vehicle adjustment device 1 has been described above, which corresponds to a camera system for detecting the outside area of a motor vehicle, wherein the camera system is a front camera system or a reversing camera system. The camera system 1 comprises a cover flap 9, which is designed as a first functional element 3, and which is movable between a closed position designed as a starting position, in which the cover flap 9 closes an opening 7c in a body wall 7b, and an open position designed as an end position, in which the opening 7c is opened, a camera support 10, which is designed as a second functional element 5 and which is movable between a rest position designed as a starting position, in which the camera support 10 is protected behind the opening 7c, into an active position in which the camera support 10 protrudes at least partially from the opening 7c, and a transmission which comprises a drive element 2, a first coupling element 11, a second coupling element 14, and an intermediate element 4. The gear mechanism is designed such that it moves both the first functional element 3 and the second functional element 5, wherein the movements of the first and second functional elements 3 and 5 are coordinated with one another in time and the movements can be carried out at different times. The flap element 9 in the form of the first functional element 3 is mounted on a functional element pivot axle 25 which is movable relative to the drive axle 6 of the drive element 2. The camera support 10 can also be moved in a guided manner via two levers 11, 39, wherein one of the two levers 11 is in mechanical operative connection with the transmission.

The invention described above is, of course, not limited to the embodiments described and depicted. It is evident that numerous modifications can be made to the embodiments shown in the drawing, which are obvious to the skilled person according to the intended application, without leaving the scope of the invention. The invention includes everything that is contained in the description and/or depicted in the drawing, including anything that, deviating from the concrete design examples, is obvious to the skilled person.

1. Motor vehicle adjustment device, comprising:
a drive element which is connected in a rotationally fixed manner to a fixed drive axle and which can be moved between a home position and an end drive position,
a first functional element which can be moved out of a starting position that starts and/or stops a function and back into the starting position by means of the drive element,
an intermediate element, which is rotatably mounted about a fixed rotation axle between a basic position and an end drive position and which can be moved by means of the drive element, and
a second functional element which can be moved by means of the intermediate element between a starting position that starts and/or stops a function and an end position that starts and/or ends a function,
wherein the drive element is designed to pass through an intermediate position during its movement from the starting position into the end drive position, wherein the drive element is in mechanical operative connection with the first functional element and the first functional element is designed to move out of the starting position that starts and/or stops a function as said drive element moves from the starting position into the intermediate position,
wherein the drive element is movably coupled to the intermediate element and when it moves from the intermediate position to the end drive position, the intermediate element is designed to move from the basic position to the end drive position, and
wherein the intermediate element is in mechanical operative connection with the second functional element and the second functional element is designed, as it moves from the basic position into the end dive position, to move from the starting position that starts and/or stops a function into the end position that starts and/or stops a function.

2. Motor vehicle adjustment device according to claim 1, wherein the drive element has a drive pin which is radially spaced from the drive axle, wherein the intermediate element has a guide recess which is designed to extend in a radially spaced manner relative to the rotation axle and in which the drive pin is arranged to be movable.

3. Motor vehicle adjustment device according to claim 2, wherein the guide recess of the intermediate element has a first recess portion, which has a constant radius with respect to the drive axle of the drive element and has a second recess portion which has an increasing radius with respect to the drive axle of the drive element.

4. Motor vehicle adjustment device according to claim 3, wherein the drive pin is arranged to move along the first recess portion as the drive element moves from the home position into the intermediate position, and wherein the drive pin is arranged to move along the second recess portion and the intermediate element is arranged to rotate about the rotation axle as the drive element moves from the intermediate position into the end drive position.

5. Motor vehicle adjustment device according to claim 1, further comprising a first coupling element which is pivotably mounted about a first fixed pivot axle between a rest position and a limit position, wherein the first coupling element mechanically operatively connects the drive element to the first functional element.

6. Motor vehicle adjustment device according to claim 5, wherein the drive element is designed, as it moves from the starting position into the intermediate position, to move the first coupling element from the rest position into the limit position,
and wherein the drive element has a drive recess which is designed to run radially spaced from the drive axle, wherein the first coupling element is designed having a coupling pin which is arranged radially spaced from the first pivot axle and is movably arranged in the drive recess.

7. Motor vehicle adjustment device according to claim 6, wherein the drive recess of the drive element has a first drive recess portion, which has a decreasing radius with respect to the drive axle, and a second drive recess portion, which has a constant radius with respect to the drive axle.

8. Motor vehicle adjustment device according to claim 7, wherein the coupling pin is arranged to move along the first drive recess portion as the drive element moves from the home position into the intermediate position, wherein the coupling pin is arranged to move along the second drive recess portion and the first coupling element is arranged to rotate about the first fixed pivot axle as the drive element moves from the intermediate position into the end drive position.

9. Motor vehicle adjustment device according to claim 6, wherein the first coupling element is formed having a first lever arm and a second lever arm, wherein the coupling pin is formed at the end of the first lever arm, wherein a coupling projection protrudes from the first functional element, which is rotatably supported at the end on a stationary folding axle and which is rotatably connected to the second lever arm.

10. Motor vehicle adjustment device according to claim 6, wherein the first coupling element has a first lever element which is rotatably mounted about a first fixed lever rotation axle, and has a second lever element which is rotatably mounted about a second fixed lever rotation axle,
wherein the first lever element has a first lever arm, on which the coupling pin is formed, and has a second lever arm, on which a lever movement pin is formed on the end, and
wherein the second lever element is rotatably connected to the first functional element and has a lever recess guiding the lever movement pin, which is formed radially offset from the second fixed lever rotation axle.

11. Motor vehicle adjustment device according to claim 10, wherein the first functional element has a movement guide attachment which is movably arranged in a movement guide recess, wherein the movement guide recess is designed as a stationary elongated hole.

12. Motor vehicle adjustment device according to claim 10, wherein the first lever element has a third lever arm in which an elongated hole is formed, in which a movement guide projection protruding from the first functional element is movably guided.

13. Motor vehicle adjustment device according to claim 10, wherein the first coupling element is formed, as it moves from the rest position into the limit position, to move the first functional element from the starting position that starts and/or stops a function into the end position.

14. Motor vehicle adjustment device according to claim 6, wherein the first coupling element is formed as a lever element having a first lever arm, on which the coupling pin is formed at the end, and having a second lever arm,
wherein the second lever arm is formed having an elongated hole in which a movement guide projection protruding from the first functional element is arranged so as to be movable.

15. Motor vehicle adjustment device according to claim 14, comprising a movement lever, of which a first longitudinal end is rotatably connected to the intermediate element and of which a second longitudinal end is rotatably connected to the first functional element.

16. Motor vehicle adjustment device according to claim 15, wherein the first coupling element is formed, as it moves from the rest position into the limit position, to move the first functional element from the starting position that starts and/or stops a function into the intermediate functional position, and
wherein the movement lever is designed to move the first functional element from the intermediate functional position into the end position when the intermediate element moves from the basic position into the end drive position.

17. Motor vehicle adjustment device according to claim 1, further comprising a second coupling element which is pivotally mounted about a second fixed pivot axle between a rest position and a limit position, wherein the second coupling element mechanically operatively connects the intermediate element to the second functional element.

18. Motor vehicle adjustment device according to claim 17, wherein the second coupling element is rotatably connected to the second functional element via a pivot point arranged radially spaced from the second fixed pivot axle.

19. Motor vehicle adjustment device according to claim 17, wherein the intermediate element is designed, as it moves from the basic position into the end drive position, to move the second coupling element from the rest position into the limit position, and
wherein the second coupling element, as it moves from the rest position into the limit position, is designed to move the second functional element from a starting position that starts and/or stops a function to an end position that starts and/or stops a function.

20. Motor vehicle adjustment device according to claim 17, wherein the second coupling element has a coupling recess which is radially spaced from the second fixed pivot axle, wherein the intermediate element is designed having an intermediate element pin which is arranged at a radial distance from the rotation axle and is movably arranged in the coupling recess.

21. Motor vehicle adjustment device according to claim 20, wherein the coupling recess of the second coupling element has a first coupling recess portion, which has an increasing radius with respect to the second fixed pivot axle, and a second coupling recess portion.

22. Motor vehicle adjustment device according to claim 21, wherein as the intermediate element moves from the basic position into the end drive position, the intermediate element pin is arranged to move along the first drive recess portion and the second coupling element is arranged to rotate from the rest position into the limit position.

23. Motor vehicle adjustment device according to claim 1, wherein at least the drive element and the intermediate element are mounted within a protective housing or wherein a cover element is arranged to the side of the drive element and laterally covers at least the drive element, the intermediate element, and the second functional element.

24. Motor vehicle adjustment device according to claim 1, wherein the first functional element is pivotally mounted about a functional element pivot axle, wherein the functional element pivot axle is relatively movable relative to the fixed drive axle.

25. Motor vehicle adjustment device according to claim 1, further comprising a guide lever which is rotatably mounted on a fixed guide rotation axle and is rotatably connected to the second functional element.

26. Motor vehicle adjustment device according to claim 1, wherein the first functional element is designed as a cover flap and the second functional element is designed as a camera or a camera mount, wherein, in the starting position, the cover flap covers the camera or the camera carrier to protect it against an external environment and the camera or the camera carrier is arranged in a protective manner behind the cover flap in the starting position, and wherein, in the end position, the cover flap is arranged to open up a recording area for the camera and the camera or camera carrier is arranged in the end position on the recording area.
